(19) United States
(12) Patent Application Publication
(10) Pub. No.: US 2016/0124674 A1
(43) Pub. Date: May 5, 2016

(54) METHOD AND APPARATUS FOR MANAGING A PLURALITY OF MEMORY DEVICES

(71) Applicant: Samsung Electronics Co., Ltd., Gyeonggi-do (KR)

(72) Inventors: Bo-Young Seo, Seoul (KR); Min-Jung Kim, Gyeonggi-do (KR); Jung-Yup Kang, Gyeonggi-do (KR); Sei-Jin Kim, Gyeonggi-do (KR); Dong-Wook Suh, Gyeonggi-do (KR); Sung-Hwan Yun, Gyeonggi-do (KR)

(21) Appl. No.: 14/932,883

(22) Filed: Nov. 4, 2015

(30) Foreign Application Priority Data
Nov. 4, 2014 (KR) 10-2014-0152286

(51) Int. Cl. G06F 3/06

(52) U.S. Cl. CPC G06F 3/0631; G06F 3/0604; G06F 3/0685

(57) ABSTRACT

Provided is a method and apparatus for controlling a plurality of memory devices. According to various embodiments of the present disclosure, there is provided an electronic device. The electronic device includes a first memory and a second memory, and a processor that is functionally connected with the first memory and the second memory. The processor is configured to determine at least one state associated with the electronic device, and allocate at least a partial area of one of the first memory and the second memory to at least some data of at least one process to be executed in the electronic device based on the at least one state. Other embodiments are possible.

### CROSS-REFERENCE TO RELATED APPLICATIONS AND CLAIM OF PRIORITY

The present application is related to and claims benefit under 35 U.S.C. §119(a) to Korean Application Serial No. 10-2014-0152286, which was filed in the Korean Intellectual Property Office on Nov. 4, 2014, the entire content of which is hereby incorporated by reference.

### TECHNICAL FIELD

The present disclosure relates to an electronic device, and particularly, to a method and apparatus for managing a plurality of memory devices included in the electronic device.

### BACKGROUND

Electronic devices have come to include a plurality of volatile memory devices to quickly process a large amount of information. A volatile memory is a computer memory that requires electricity to maintain stored information, unlike a non-volatile memory that does not require a continuous power supply. Electronic devices may include, for example, a low power double data rate (LPDDR), as a volatile memory device. The LPDDR is obtained by modifying a DDR synchronous DRAM (SDRAM) many times to reduce power consumption. Also, electronic devices may include a Wide I/O that provides a relatively higher bandwidth than the LPDDR. The Wide I/O is, for example, a memory device that is directly connected to a logic (for example, a memory controller or System on Chip (SOC)) using a three dimensional (3D) through silicon via (TSV) scheme.

### SUMMARY

According to the conventional art, although an electronic device includes heterogeneous memory devices having different properties, the electronic device indiscriminately allocates the plurality of memory devices to a process, without taking into consideration the properties of the heterogeneous memory devices. For example, a general electronic device allocates a free area out of the entire memory area in response to a memory allocation request from the process. Also, according to the conventional art, the electronic device allocates a memory area without taking into account the state of the electronic device (for example, the temperature of the electronic device, current consumption, or the like) or properties of the process (for example, a driving time of the process or the like), and thus, the electronic device may ineffectively use the memory devices. For example, when the temperature of the electronic device is higher than usual, a general electronic device does not require data (data or command) space from a memory device that shows a better heat radiating performance, and randomly allocates a memory area. In this instance, the temperature of the electronic device may become higher and thus, the performance of the electronic device may be deteriorated.

According to various embodiments of the present disclosure, an electronic device allocates a memory area based on the state of the electronic device or the property of a process and thus, may effectively utilize the memory devices. For example, when the temperature of the electronic device is included in a designated range, the electronic device according to various embodiments of the present disclosure allocates a data space using a memory which shows a better heat radiating performance and thus, results in adjusting the temperature of the electronic device and improving the performance.

To address the above-discussed deficiencies, it is a primary object to provide an electronic device according to an embodiment of the present disclosure. The electronic device includes a first memory and a second memory, and a processor that is functionally connected with the first memory and the second memory. The processor is configured to determine at least one state associated with the electronic device. The processor is also configured to allocate at least a partial area of one of the first memory and the second memory to at least some data of at least one process to be executed in the electronic device, based on the at least one state.

An electronic device, and method according to various embodiments of the present disclosure, allocates a memory area where a process operates, based on, for example, the properties of heterogeneous memory devices. The electronic device effectively uses the heterogeneous memory devices having different properties.

An electronic device, and method according to various embodiments of the present disclosure, allocates a memory area where processes operate based on, for example, at least one of a state of the electronic device and a property of the process. The electronic device improves the drawback in association with a current consumption and an increase in temperature of the electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a block diagram of an example electronic device in a network environment according to various embodiments of the present disclosure;

FIG. 1B is a block diagram of an example electronic device according to various embodiments of the present disclosure;

FIG. 2 is a block diagram of an example electronic device according to various embodiments of the present disclosure;

FIG. 3 illustrates an example of allocating a memory area in an electronic device according to various embodiments of the present disclosure;

FIG. 4 illustrates an example of allocating a memory area in an electronic device according to various embodiments of the present disclosure;

FIG. 5 illustrates an example of allocating a memory area in an electronic device according to various embodiments of the present disclosure;

FIG. 6 illustrates an example of allocating a memory area in an electronic device according to various embodiments of the present disclosure;

FIG. 7 illustrates an example of operating a processor and a memory device in an electronic device according to various embodiments of the present disclosure;

FIG. 8 illustrates an example of a relationship between a physical memory space and a virtual memory space in an electronic device according to various embodiments of the present disclosure;

FIG. 9 illustrates an example of utilizing a physical memory space and a virtual memory space in an electronic device according to various embodiments of the present disclosure;

FIG. 10 illustrates an example of a structure of a memory controller and a memory device in an electronic device according to various embodiments of the present disclosure;

FIG. 11 is a flowchart illustrating an example of a method for an electronic device to allocate a memory area according to various embodiments of the present disclosure;

FIG. 12 is a flowchart illustrating an example of a method for an electronic device to allocate a memory area according to various embodiments of the present disclosure;

FIG. 13 illustrates an example of managing a memory area in an electronic device according to various embodiments of the present disclosure;

FIG. 14 illustrates an example of managing a memory area in an electronic device according to various embodiments of the present disclosure;

FIG. 15 is a flowchart illustrating an example of a method for an electronic device to manage a memory area according to various embodiments of the present disclosure;

FIG. 16 is a block diagram of an electronic device according to various embodiments of the present disclosure;

FIG. 17 illustrates an example of allocating a memory in an electronic device according to various embodiments of the present disclosure;

FIG. 18 illustrates an example of allocating a memory in an electronic device according to various embodiments of the present disclosure;

FIG. 19 illustrates an example of a user interface for selecting a usage mode in an electronic device according to various embodiments of the present disclosure;

FIG. 20 illustrates an example of a method for an electronic device to allocate a memory area according to various embodiments of the present disclosure;

FIG. 21 illustrates an example of a method for an electronic device to allocate a memory area in an electronic device according to various embodiments of the present disclosure; and

FIG. 22 is a block diagram of an electronic device according to various embodiments.

### DETAILED DESCRIPTION

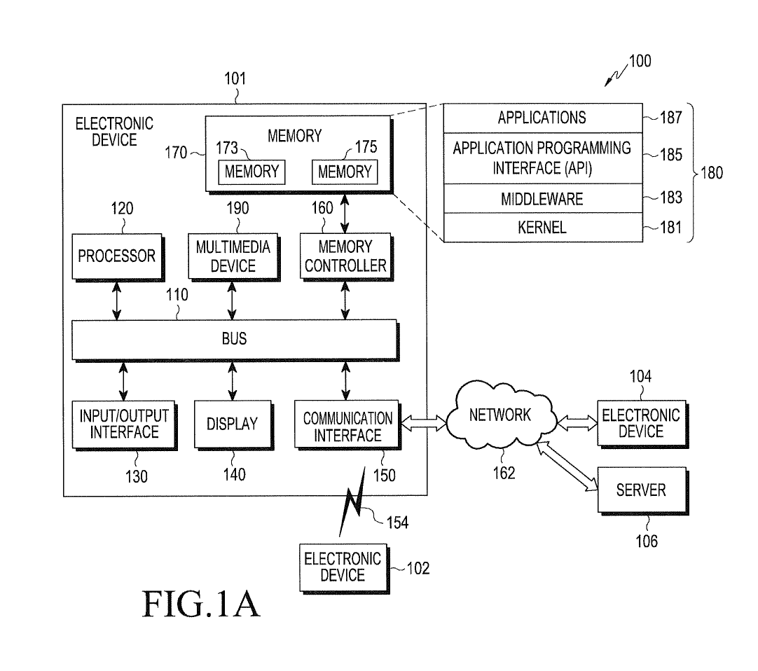

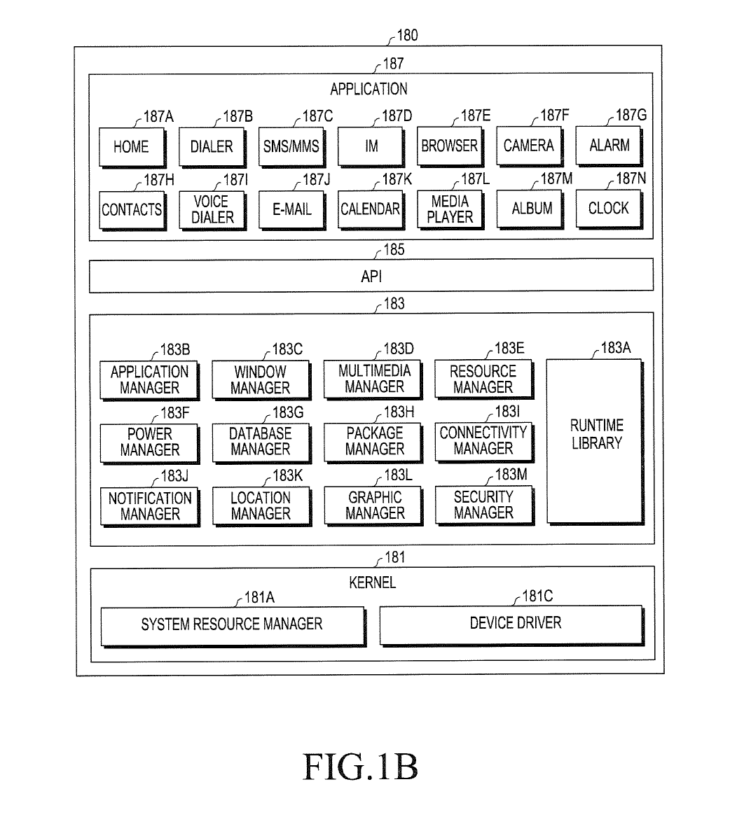

FIGS. 1A through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of according to” the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

For example, the electronic device includes at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to some embodiments, the electronic device is a smart home appliance. The home appliance includes at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., SUMSUNG HOMESYNC™, APPLE TV™, or GOOGLE TV™), a game console (e.g., XBOX™ and PLAYSTATION™), an electronic dictionary, an electronic key, a camcorder, and an electronic photo frame.

According to another embodiment, the electronic device includes at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR) , a Flight Data Recorder (FDR) , a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device includes at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure is a combination of one or more of the aforementioned various devices. The electronic device according to some embodiments of the present disclosure is a flexible device. Further, the electronic device according to an embodiment of the present disclosure is not limited to the aforementioned devices, and includes a new electronic device according to the development of technology.

Hereinafter, an electronic device according to various embodiments of the present disclosure will be described with reference to the accompanying drawings. FIG. 1A is a block diagram of an electronic device 101 in a network environment 100 according to various embodiments of the present disclosure. The electronic device 101 includes a bus 110, a processor 120, an input/output interface 130, a display 140, a communication interface 150, a memory controller 160, a memory 170, and a multimedia device 190. According to an embodiment of the present disclosure, the electronic device 101 omits at least one of the elements or further includes other elements.

The bus 110 includes, for example, a circuit which interconnects the elements 110 to 190 and delivers a communication (for example, a control message and/or data) between the elements.

The processor 120 includes one or more of a Central Processing Unit (CPU), an Application Processor (AP), and a Communication Processor (CP). The processor 120, for example, carries out operations or data processing relating to control and/or communication of at least one other element of the electronic device 101. According to an embodiment of the present disclosure, the processor 120 further includes a cache memory disposed inside or outside the processor 120. For example, the cache memory includes a level 1 (L1) cache memory and a level 2 (L2) cache memory. The L1 cache memory is disposed inside the processor 120 and temporarily stores an instruction to be processed by the processor 120. The L2 cache memory is disposed outside the processor 120 and temporarily stores data to be processed by the processor 120.

The input/output interface 130, for example, functions as an interface that transfers instructions or data input from a user or another external device to the other element(s) of the electronic device 101. Furthermore, the input/output interface 130 outputs the instructions or data received from the other element(s) of the electronic device 101 to the user or another external device.

The display 140 includes, for example, a Liquid Crystal Display (LCD), a Light-Emitting Diode (LED) display, an Organic Light-Emitting Diode (OLED) display, a MicroElectroMechanical Systems (MEMS) display, and an electronic paper display. For example, the display 140 displays various pieces of contents (for example, text, images, videos, icons, symbols, or and the like) to the user. The display 140 includes a touch screen and receives, for example, a touch, a gesture, a proximity, or a hovering input using an electronic pen or a user's body part.

The communication interface 150, for example, establishes a communication between the electronic device 101 and an external device (for example, the first external electronic device 102, the second external electronic device 104, or a server 106). For example, the communication interface 150 is connected to a network 162 through wireless or wired communication, and communicates with an external device (for example, the second external electronic device 104 or the server 106).

The wireless communication uses at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. Also, the wireless communication includes, for example, short range communication 154. The short-range communication 154 includes at least one of, for example, WiFi, BLUETOOTH®, Near Field Communication (NFC), Global Positioning System (GPS), and the like. The wired communication include at least one of, for example, a Universal Serial Bus (USB), a High Definition Multimedia Interface (HDMI), Recommended Standard 232 (RS-232), a Plain Old Telephone Service (POTS), and the like. The network 162 includes at least one of a communication network such as a computer network (for example, a LAN or a WAN), the Internet, and a telephone network.

The memory controller 160 controls, for example, the memory 170. According to an embodiment of the present disclosure, the memory controller 160 transmits a command and/or address to the memory 170, and exchanges data with the memory 170.

The memory 170 stores, for example, instructions or data relevant to at least one other element of the electronic device 101. According to an embodiment of the present disclosure, the memory 170 includes a volatile memory and/or a non-volatile memory. Also, the electronic device 101 includes a memory 173 (hereinafter, for ease of description, referred to as “first memory device”) and a memory 175 (hereinafter, for ease of description, referred to as “second memory device”), as a volatile memory for promptly processing a large amount of information.

According to an embodiment of the present disclosure, the first memory device 173 and the second memory device 175 are heterogeneous memory devices having different bandwidths. For example, the first memory device 173 has a first bandwidth (for example, approximately 12.8 Gbyte/s). For example, the first memory device 173 is embodied as a WIDE I/O dynamic random access memory (DRAM). The descriptions associated with the WIDE I/O DRAM are disclosed in “JEDEC STANDARD WIDE I/O SINGLE DATA RATE (WIDE I/O SDR), JESD229, December 2011” or the like in detail and thus, all the contents disclosed in the above document are included in the present document.

According to an embodiment of the present disclosure, the second memory device 175 has a second bandwidth (for example, approximately 6.4 Gbyte/s). For example, the second memory device 175 is embodied as a low power double data rate (LPDDR) DRAM. The descriptions of the LPDDR DRAM is disclosed in “JEDEC STANDARD LOW POWER DOUBLE DATA RATE 3 SDRAM (LPDDR3), JESD209-3, May 2012” or the like in detail and thus, all the contents disclosed in the above document are included in the present document. The first bandwidth is larger than the second bandwidth. Here, the fact that a bandwidth is larger than another bandwidth indicates, for example, that the bandwidth is relatively higher than the other bandwidth.

According to an embodiment of the present disclosure, the first memory device 173 and the second memory device 175 can have different latency. For example, the first memory device 173 has a first latency and the second memory device 175 has a second latency which is faster than the first latency. The fact that a latency is relatively faster than another latency indicates, for example, that the latency is relatively lower than the other latency. According to an embodiment of the present disclosure, although the first memory device 173 and the second memory device 175 are controlled by a single memory controller 160, they are controlled by a memory controller configured in each of the first memory device 173 and the second memory device 175. For example, the first memory device 173 and the second memory device 175 receive a command/address from different memory controllers, and exchange data with the different memory controllers.

According to an embodiment of the present disclosure, the memory 170 stores software and/or a program 180. The program 180 includes, for example, a kernel 181, middleware 183, an Application Programming Interface (API) 185, and/or application programs (or “applications”) 187. At least some of the kernel 181, the middleware 183, and the API 185 are referred to as an Operating System (OS).

The kernel 181 controls or manages system resources (for example, the bus 120, the processor 130, the memory 170, or the like) used for performing an operation or function implemented by the other programs (for example, the middleware 183, the API 185, or the application programs 187). Furthermore, the kernel 181 provides an interface through which the middleware 183, the API 185, or the application programs 187 access the individual elements of the electronic device 101 to control or manage the system resources.

The middleware 183, for example, functions as an intermediary for allowing the API 185 or the application programs 187 to communicate with the kernel 181 to exchange data. Also, the middleware 183 processes one or more task requests received from the application programs 187 according to priorities thereof. For example, the middleware 183 assigns priorities for using the system resources (for example, the bus 110, the processor 120, the memory 170, or the like) of the electronic device 101, to at least one of the application programs 187. For example, the middleware 183 performs scheduling or loading balancing on the one or more task requests by processing the one or more task requests according to the priorities assigned thereto.

The API 185 is an interface through which the applications 187 control functions provided from the kernel 181 or the middleware 183, and includes, for example, at least one interface or function (for example, instruction) for file control, window control, image processing, text control, or the like.

The multimedia device 190 includes a two-dimensional (2D)/three-dimensional (3D) graphic engine, an image signal processor (ISP), and/or video/audio codec engine, and the like, and processes a multimedia operation.

Each of the first and second external electronic devices 102 and 104 are of a type identical to or different from that of the electronic device 101. According to an embodiment of the present disclosure, the server 106 includes a group of one or more servers. According to various embodiments of the present disclosure, all or some of the operations performed in the electronic device 101 are executed in another electronic device or a plurality of electronic devices (for example, the electronic device 102 or 104, or the server 106). According to an embodiment of the present disclosure, when the electronic device 101 has to perform some functions or services automatically or in response to a request, the electronic device 101 requests another device (for example, the electronic device 102 or 104, or the server 106) to execute at least some functions relating thereto instead of or in addition to performing the functions or services by itself. Another electronic device (for example, the electronic device 102 or 104, or the server 106) executes the requested functions or the additional functions, and delivers a result of the execution to the electronic device 101. The electronic device 101 processes the received result as it is or additionally and provides the requested functions or services. To this end, for example, cloud computing, distributed computing, or client-server computing technologies are used.

FIG. 1B illustrates an example of an electronic device (for example, the program module 180) according to this disclosure. FIG. 1B omits the description that is identical or similar to the description of FIG. 1A, while providing additional descriptions in association with the program module 180. According to an embodiment of the present disclosure, the program module 180 includes an operating system (OS) for controlling resources related to the electronic device (for example, the electronic device 101) and/or various applications (for example, the application programs 187) executed in the operating system. The operating system is, for example, ANDROID®, IO®, WINDOWS®, SYMBIAN®, TIZEN®, MAC OS®, LINUX®, UNIX®, BADA®, or the like. At least some of the program module 180 are preloaded on the electronic device, or are downloaded from an external electronic device (for example, the electronic device 102 or 104, or the server 106).

The programming module 180 includes the kernel 181, the middleware 183, the application programming interface (API) 185, and/or applications 187. The kernel 181 includes, for example, a system resource manager 181A and/or a device driver 181C. The system resource manager 181 A controls, allocates, or collects system resources. According to an embodiment of the present disclosure, the system resource manager 181A includes a process manager, a memory manager, a file system manager, or the like. The device driver 181 includes, for example, a display driver, a camera driver, a BLUETOOTH® driver, a shared memory driver, a USB driver, a keypad driver, a Wi-Fi driver, an audio driver, or an Inter-Process Communication (IPC) driver.

The middleware 183 provides a function required by the applications 187 in common or provide various functions to the applications 187 through the API 185 so that the applications 187 efficiently use limited system resources within the electronic device. According to an embodiment of the present disclosure, the middleware 183 includes at least one of a runtime library 183A, an application manager 183B, a window manager 183C, a multimedia manager 183D, a resource manager 183E, a power manager 183F, a database manager 183G, a package manager 183H, a connectivity manager 1831, a notification manager 183J, a location manager 183K, a graphic manager 183L, and a security manager 183M.

The runtime library 183A includes a library module that a compiler uses in order to add a new function through a programming language while the applications 187 are being executed. The runtime library 183A performs input/output management, memory management, the functionality for an arithmetic function, or the like.

The application manager 183B manages, for example, the life cycle of at least one of the applications 187. The window manager 183C manages Graphical User Interface (GUI) resources used in the screen. The multimedia manager 183D determines a format required to reproduce various media files, and encodes or decodes a media file by using a coder/decoder (codec) appropriate for the corresponding format. The resource manager 183E manages resources such as a source code of at least one of the applications 187, a memory, and a storage space.

The power manager 183F, for example, operates together with a basic input/output system (BIOS) to manage a battery or power, and provides power information required for the operation of the electronic device. The database manager 183G generates, searches for, and/or changes a database to be used by at least one of the applications 187. The package manager 183H manages the installation or update of an application distributed in the form of a package file.

The connectivity manager 1831 manages a wireless connection such as, for example, Wi-Fi or BLUETOOTH®. The notification manager 183J displays or reports an event, such as an arrival message, an appointment, a proximity notification, and the like, in such a manner not to disturb the user. The location manager 183K manages location information of the electronic device. The graphic manager 183L manages a graphic effect, which is to be provided to the user, or a user interface related to the graphic effect. The security manager 183M provides various security functions required for system security, user authentication, and the like. According to an embodiment of the present disclosure, when the electronic device (for example, the electronic device 101) has a telephone call function, the middleware 183 further includes a telephony manager for managing a voice call function or a video call function of the electronic device.

The middleware 183 includes a middleware module that forms a combination of various functions of the above-described elements. The middleware 183 provides a module specialized for each type of OS in order to provide a differentiated function. Also, the middleware 183 dynamically deletes some of the existing elements, or adds new elements.

The API 185 is, for example, a set of API programming functions, and is provided in a different configuration based on an OS. For example, in the case of ANDROID® or MS®, one API set is provided for each platform. In the case of TIZEN®, two or more API sets are provided for each platform.

The applications 187 include, for example, one or more applications which perform functions such as a home 187A, a dialer 187B, an SMS/MMS 187C, an Instant Message (IM) 187D, a browser 187E, a camera 187F, an alarm 187G, contacts 187H, a voice dialer 1871, an email 187J, a calendar 187K, a media player 187L, an album 187M, a clock 187N, health care (for example, measure exercise quantity or blood sugar), or environment information (for example, atmospheric pressure, humidity, or temperature information).

According to an embodiment of the present disclosure, the applications 187 includes an application (hereinafter referred to as an “information exchange application” for ease of description) supporting exchanging of information between the electronic device (for example, the electronic device 101) and an external electronic device (for example, the electronic device 102 or 104, or the server 106). The information exchange application includes, for example, a notification relay application for transferring specific information to an external electronic device or a device management application for managing an external electronic device.

For example, the notification relay application includes a function of delivering, to the external electronic device (for example, the electronic device 102 or 104, or the server 106), notification information generated by other applications (for example, an SMS/MMS application, an email application, a health care application, an environmental information application, and the like) of the electronic device 101. Further, the notification relay application receives notification information from, for example, an external electronic device, and provides the received notification information to a user.

The device management application, for example, manages (for example, install, delete, or update) at least one function of an external electronic device (for example, the electronic device 102 or 104, or the server 106) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment of the present disclosure, the applications 187 includes applications (for example, a health care application of a mobile medical appliance or the like) designated based on the property of an external electronic device (for example, the electronic device 102 or 104, or the server 106). According to an embodiment of the present disclosure, the application 187 includes an application received from an external electronic device (for example, the server 106, or the electronic device 102 or 104). According to an embodiment of the present disclosure, the applications 187 include a preloaded application or a third party application which is downloaded from a server. Names of the elements of the program module 180, according to the above-described embodiments of the present disclosure, may change depending on the type of OS.

According to various exemplary embodiments of the present disclosure, at least some of the program module 180 is implemented in software, firmware, hardware, or a combination of two or more thereof. At least some of the program module 180 is implemented (e.g., executed) by, for example, the processor (e.g., the processor 120). At least some of the program module 180 includes, for example, a module, a program, a routine, a set of instructions, and/or a process for performing one or more functions.

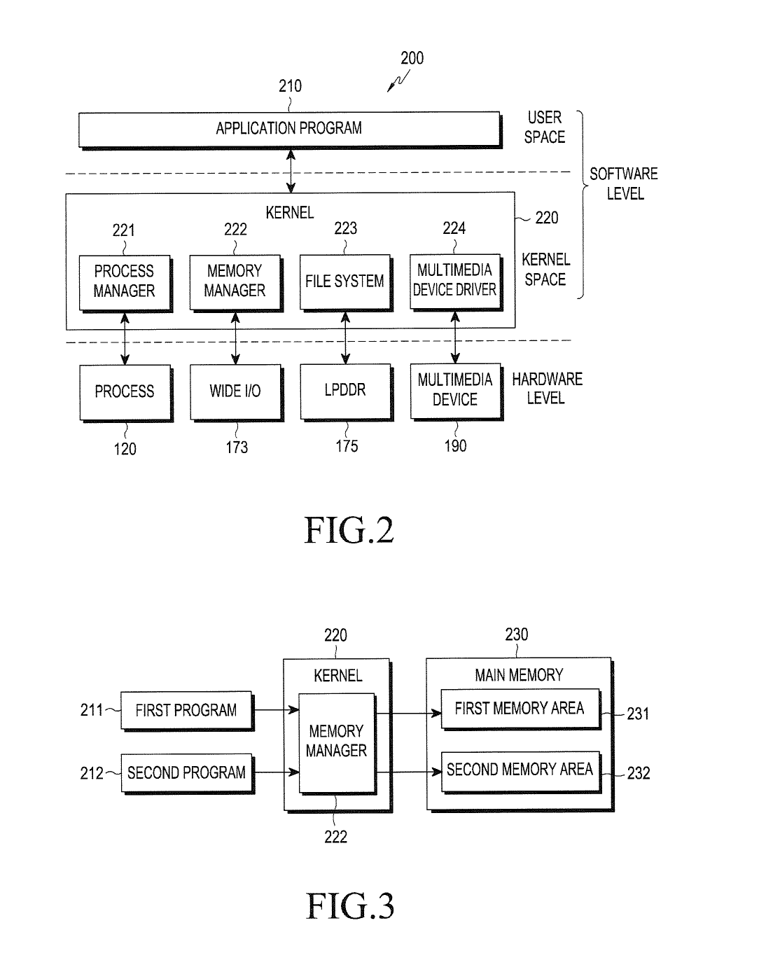

FIG. 2 is a block diagram of an electronic device according to this disclosure. The descriptions identical or similar to the descriptions of FIG. 1A and FIG. 1B will be omitted. Referring to FIG. 2, an electronic device 200 (for example, the electronic device 101), is formed in a layered structure that is divided into, for example, a software level (S/W LEVEL) and a hardware level (H/W LEVEL). The software level is divided into, for example, a user space and a kernel space. In the user space, an application program 210 (for example, the application 187) is executed. For example, although the application program 210 includes a shell-based program and a Graphic User Interface (GUI)-based program, various embodiments of the present disclosure may not be limited thereto.

The application program 210 requires resources of the hardware (for example, the processor 120, the first memory device 173, the second memory device 175, the multimedia device 190, or the like) of the electronic device 200. The application program 210 may not directly access the hardware, but indirectly accesses the same through a kernel 220 (for example, the kernel 181). The application program 210 uses a function of the kernel 220 using a system call.

The kernel 220 is executed in the kernel space. The kernel 220 is a part of the operating system (OS), and manages resources of the hardware of the electronic device 200 or provides hardware abstraction. The kernel 220 manages a process, a memory, a file system, input/output, or the like. To this end, the kernel 220 includes various modules such as a process manager 221, a memory manager 222, a file system manager 223, a multimedia device driver 224 (for example, the device driver 181C), or the like, but various embodiments of the present disclosure may not be limited thereto.

FIG. 3 illustrates an example of allocating a memory area in an electronic device (for example, the electronic device 101) according to various embodiments of the present disclosure. Referring to FIG. 3, the memory manager 222 manages, for example, a main memory (MAIN MEMORY) 230 of the electronic device (for example, the electronic device 101). The memory manager 222 allocates a memory and collects a memory. The memory manager 222 receives a memory allocation request from one or more programs, and allocates a memory area of the main memory 230 to one or more programs. According to an embodiment of the present disclosure, the memory manager 222 is driven, residing in the processor 120.

The main memory 230 includes, for example, a first memory area 231 and a second memory area 232. The first memory area 231 and the second memory area 232 are physically or logically distinguished. The first memory area 231 and the second memory area 232 are provided from different memory devices. For example, the first memory area 231 is provided from a first memory device (for example, the first memory device 173) and the second memory area 232 is provided from a second memory device (for example, the second memory device 175). According to an embodiment of the present disclosure, the first memory area 231 and the second memory area 232 are defined by different address spaces.

The memory manager 222 determines a memory area to be allocated to a program that transmits a memory allocation request, out of the first memory area 231 and the second memory area 232. The memory manager 222 allocates a memory area appropriate for the program that transmits the memory allocation request, based on the properties of heterogeneous memory devices.

For example, a first program 211 and a second program 212 are driven by a processor (processor 120). The memory manager 222 allocates the first memory area 231 to the first program 211 in response to a memory allocation request from the first program 211. Unlike the above, the memory manager 222 allocates the second memory area 232 to the second program 212 in response to a memory allocation request from the second program 212.

The first program 211 executes an instruction loaded onto the first memory area 231, or writes/reads data on the first memory area 231. The second program 212 executes an instruction loaded onto the second memory area 232, or writes/reads data on the second memory area 232. Each program access, for example, only an allocated memory area, and may not access an unallocated memory area.

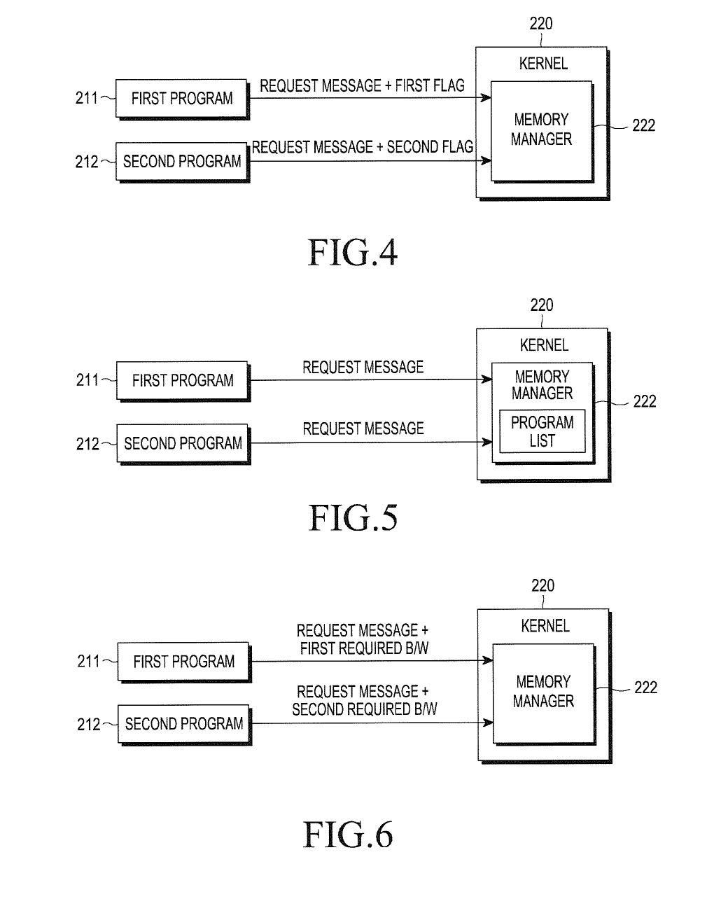

FIG. 4 illustrates an example of allocating a memory area in an electronic device (for example, the electronic device 101) according to this disclosure. Referring to FIG. 4, the first program 211 and the second program 212 transmit a flag to the memory manager 222 when requesting the allocation of a memory. For example, although the memory allocation request includes a request message or a flag, various embodiments of the present disclosure may not be limited thereto. For example, the first program 211 transmits a request message and a flag together to the memory manager 222, to request the allocation of a memory. Alternatively, the first program 211 transmits a request message or a flag separately to the memory manager 222, to request the allocation of a memory.

The second program 212 transmits a memory allocation request including a second flag to the memory manager 222 of the kernel 220 (for example, the kernel 181). The memory manager 222 uses a first flag and a second flag to determine a memory area to be allocated, out of a first memory area (for example, the first memory area 231) and a second memory area (for example, the second memory area 232). The first flag indicates requesting a memory area (for example, the first memory area 231) of a first memory device having a relatively higher bandwidth (for example, a WIDE I/O as the first memory device 173). Conversely, the second flag indicates requesting a memory area (for example, the second memory area 232) of a second memory device (for example, an LPDDR as the second memory device 175) having a relatively lower bandwidth (having a relatively lower latency).

FIG. 5 illustrates an example of allocating a memory area in an electronic device (for example, the electronic device 101) according to this disclosure. Referring to FIG. 5, the memory manager 222 of the kernel 220 (for example, the kernel 181), includes, for example, a program list (PROGRAM LIST). According to an embodiment of the present disclosure, the program list includes an identifier of the first program 211 or an identifier of the second program 222. Each of the first program 211 and the second program 212 transmits a corresponding memory allocation request to the memory manager 222. Each memory allocation request is formed of a request message, and an identifier of each program is included in the request message.

The memory manager 222 uses the program list to determine a memory area to be allocated, out of a first memory area (for example, the first memory area 231) and a second memory area (for example, the second memory area 232). Depending on a type of program, the memory manager 222 allocates a memory area of a first memory device (for example, the first memory device 173) having a relatively higher bandwidth to the first program 211, and allocates a memory area of a second memory device (for example, the second memory device 175) having a relatively lower bandwidth to the second program 212. According to an embodiment of the present disclosure, a method of allocating a different memory area based on a type of program is set in advance in a designing or manufacturing phase of an electronic device, or is set in advance by a user while the user uses the electronic device.

FIG. 6 illustrates an example of allocating a memory area in an electronic device (for example, the electronic device 101) according to this disclosure. Referring to FIG. 6, the first program 211 and the second program 212 transmit information associated with a required bandwidth (B/W) to the memory manager 222 of the kernel 220 when requesting the allocation of a memory.

For example, the memory allocation request is formed of a request message and a required B/W, various embodiments of the present disclosure may not be limited thereto. For example, the first program 211 transmits a request message and a required B/W together to the memory manager 222, to request the allocation of a memory. Alternatively, the first program 211 transmits information associated with a request message or a required B/W separately to the memory manager 222, to request the allocation of a memory.

The first program 211 transmits a memory allocation request including a first required B/W to the memory manager 222. The second program 212 transmits a memory allocation request including a second required B/W to the memory manager 222. The memory manager 222 compares a required B/W and a reference B/W to determine a memory area to be allocated, out of the first memory area (for example, the first memory area 231) and the second memory area (for example, the second memory area 232). For example, the reference B/W is approximately 6.4 Gbyte/s, which is similar or identical to the bandwidth of the second memory device (for example, the second memory device 175).

According to an embodiment of the present disclosure, the memory manager 222 allocates a memory area (for example, the first memory area 231) of the first memory device (for example, the first memory device 173) when the required B/W is larger than the reference B/W, and allocates a memory area (for example, the second memory area 232) of the second memory area (for example, the second memory device 175) when the required B/W is not larger than the reference B/W. For example, the first required B/W is larger than the reference B/W, and the second required B/W may not be larger than the reference B/W. In this instance, the memory manager 222 allocates the first memory area of the first memory device to the first program 211 that transmits a memory allocation request including the first required B/W. The memory manager 222 allocates the second memory area of the second memory device to the second program 212 that transmits a memory allocation request including the second required B/W.

According to an embodiment of the present disclosure, the first program 211 or the second program 212 transmits a memory allocation request by additionally including a required latency. Also, the memory manager 222 compares a required latency and a reference latency to determine a memory area to be allocated out of the first memory area and the second memory area.

The memory manager 222 allocates the second memory area (for example, the second memory area 232) of the second memory device (for example, the second memory device 175) when the required latency is faster than the reference latency, and allocates the first memory area (for example, the first memory area 231) of the first memory device (for example, the first memory device 171) when the required latency is not faster than the reference latency.

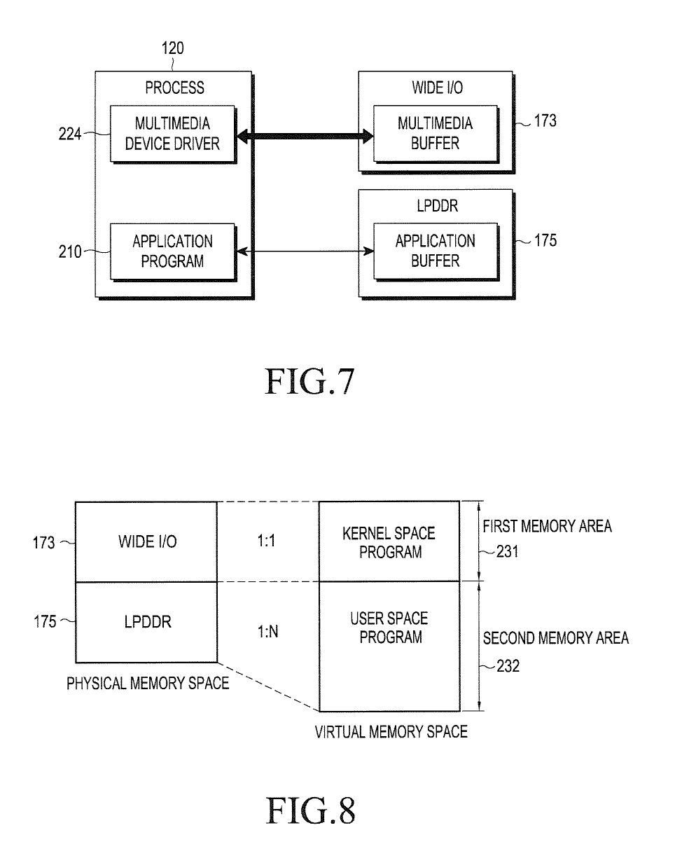

FIG. 7 illustrates an example of operating a processor (for example, the processor 120) and a memory device (for example, the memory 170) in an electronic device (for example, the electronic device 101), according to this disclosure. Referring to FIG. 7, as an example, the multimedia device driver 224 is applied as a first program (for example, the first program 211) and the application program 210 is applied as a second program (for example, the second program 212).

The multimedia device driver 224 controls a multimedia device (for example, the multimedia device 190) and provides an interface between one or more programs and a multimedia device. The application program 210 is a computer program that is executed by a user, and executes a predetermined task. The multimedia device driver 224 and the application program 210 are driven by the processor 120.

In the case of the electronic device 101 including heterogeneous memory devices according to an embodiment of the present disclosure, the memory manager 222 preferentially allocates a multimedia buffer that requires a relatively higher bandwidth to a memory area of the first memory device 173, and preferentially allocates an application buffer that requires a relatively lower bandwidth to a memory area of the second memory device 175. The first memory device 173 is embodied as, for example, a WIDE I/O DRAM, and the second memory device 175 is embodied as, for example, an LPDDR DRAM.

According to an embodiment of the present disclosure, the memory manager 222 allocates a multimedia buffer to the memory area of the first memory device 173 that has a relatively higher bandwidth, in response to a memory allocation request from the multimedia device driver 224. The memory manager 222 allocates an application buffer to the memory area of the second memory device 175 which has a relatively lower bandwidth, in response to the memory allocation request from the application program. As described above, an electronic device that includes heterogeneous memory devices according to various embodiments of the present disclosure allocates a memory appropriate for the purpose of use of each program, to a corresponding program, and thus, improves the performance of the electronic device.

FIG. 8 illustrates an example of a relationship between a physical memory space and a virtual memory space in an electronic device (for example, the electronic device 101) according to this disclosure. Referring to FIG. 8, a physical memory space (PHYSICAL MEMORY SPACE) includes the first memory device 173 (for example, WIDE I/O) and the second memory device 175 (for example, LPDDR DRAM). The physical memory device is accessed, based on, for example, a physical memory address.

A virtual memory space (VIRTUAL MEMORY SPACE) corresponding to the physical memory space includes the first memory area 231 and the second memory area 232. The first memory area 231 and the second memory area 232 are provided from, for example, different memory devices. For example, the first memory area 231 is provided from the first memory device 173, and the second memory area 232 is provided from the second memory device 175. The virtual memory space is accessed, based on, for example, a virtual memory address.

According to an embodiment of the present disclosure, each of the first memory area 231 and the second memory area 232 includes an independent address space. The first memory area 231 provides a virtual memory space which is the same size as the physical memory space of the first memory device 173. The second memory area 232 provides a virtual memory space which is larger than the physical memory space of the second memory device 175. According to an embodiment of the present disclosure, a memory manager (for example, the memory manager 222) provides the first memory area 231 to a program of a kernel space. The memory manager provides the second memory area 232 to a program of a user space.

According to an embodiment of the present disclosure, the memory manager dynamically allocates a memory area in response to a memory allocation request of the kernel space or the user space during a run time. The memory manager allocates the memory area 231 of the first memory device 173 which has a relatively higher bandwidth, in response to a memory allocation request from the program of the kernel space. The memory manager allocates the memory area 232 of the first memory device 175 which has a relatively lower bandwidth, in response to a memory allocation request from the program of the user space.

The memory manager statically reserves a memory area for using the program of the kernel space or the user space during a compile time. The memory manager reserves the memory area 231 of the first memory device 173 which has a relatively higher bandwidth, as a memory to be used by the program of the kernel space. The memory manager 222 reserves the memory area 232 of the first memory device 175 which has a relatively lower bandwidth (for example, relatively lower latency) as a memory to be used by the program of the user space.

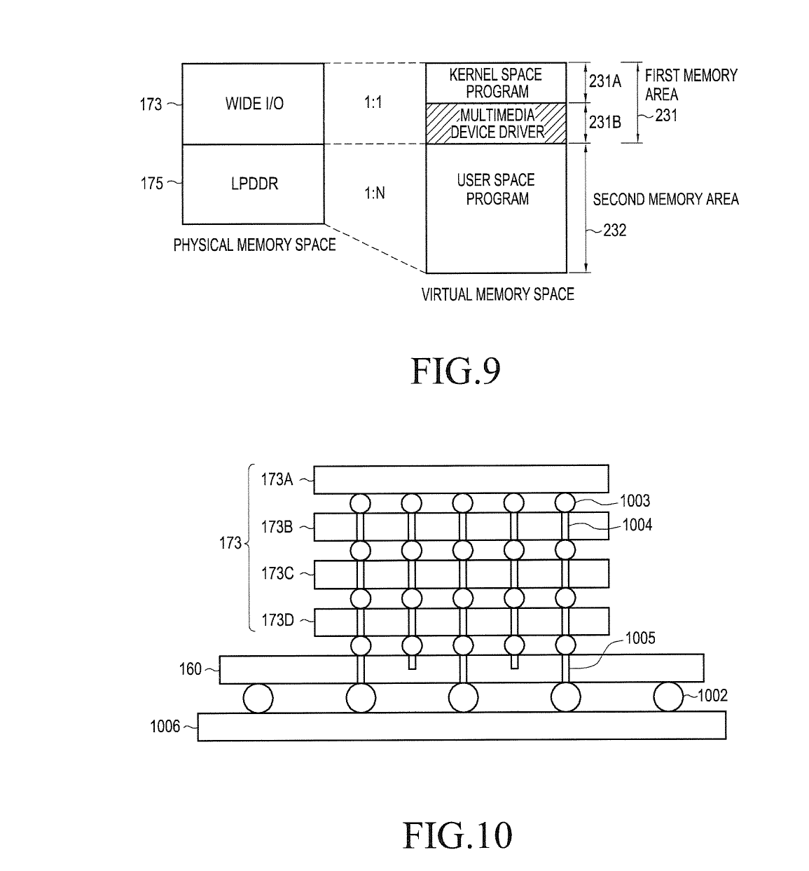

FIG. 9 illustrates an example of utilizing a physical memory space and a virtual memory space in an electronic device (for example, the electronic device 101) according to this disclosure. The descriptions that are identical or similar to the descriptions of FIG. 8 will be omitted. Referring to FIG. 9, a physical memory space of the electronic device (for example, the electronic device 101) includes the first memory device 173 and the second memory device 175. A virtual memory space corresponding to the physical memory space is formed of, for example, the first memory area 231 and the second memory area 232.

According to an embodiment of the present disclosure, the first memory area 231 includes a plurality of areas 231A and 231B. The memory manager (for example, the memory manager 222) provides one area 231A out of the first memory area 231 to a few programs of the kernel space (for example, the process manager 221), and provides the other area 231B to the multimedia device driver 224. For example, a multimedia buffer is provided in the other area 231B. The memory manager provides the second memory area 232 to a program of a user space.

FIG. 10 illustrates an example of a structure of a memory controller (for example, the memory controller 160) and a memory device (for example, the first memory device 173) of an electronic device (for example, the electronic device 101), according to this disclosure. Referring to FIG. 10, the memory controller 160 and the first memory device 173 are packaged using a 3D TSV scheme. For example, the first memory device 173 includes a plurality of layered memory chips 173A, 173B, 173C, and 173D. The plurality of layered memory chips 173A, 173B, 173C, and 173D is electrically connected to one another by micro-bumps 1003 and TSVs 1004 formed in the memory chips 173A, 173B, 173C, and 173D. The memory controller 160 is layered on a substrate 1006, and is electrically connected to the substrate 1006 by flip-chip bumps 1002.

According to an embodiment of the present disclosure, the first memory device 173 is layered on the memory controller 160 based on a face-to-back (F2B) scheme. The first memory device 173 and the memory controller 160 are electrically connected by the bumps and the TSVs 1005 formed in the memory controller 160. According to various embodiments of the present disclosure, the memory controller 160 and the first memory device 173 are packaged based on the 3D TSV scheme and thus, an occupied area of the memory device is decreased and an input/output bandwidth is increased.

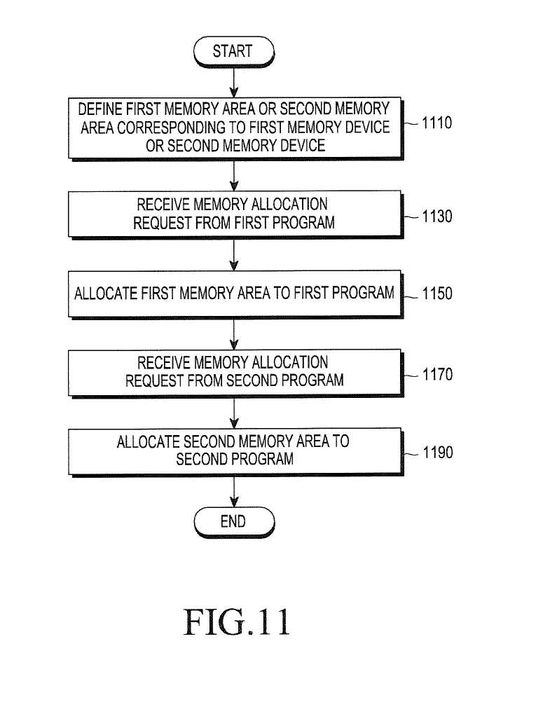

FIG. 11 is a flowchart illustrating an example of a method for an electronic device (for example, the electronic device 101) to allocate a memory area according to this disclosure. Referring to FIG. 11, in operation 1110, an electronic device (for example, the memory manager 222) defines a first memory area (for example, the first memory area 231) and a second memory area (for example, the second memory area 232) which respectively correspond to a first memory device (for example, the first memory device 173) and a second memory device (for example, the second memory device 175). According to an embodiment of the present disclosure, the memory manager uses hardware information of the first memory device and the second memory device. The first memory area and the second memory area are defined by different address spaces.

In operation 1130, the electronic device (for example, the memory manager 222) receives a memory allocation request from a first program. For example, the first program is a program of a kernel space. In operation 1150, the electronic device (for example, the memory manager 222) preferentially allocates the first memory area to the first program in response to the memory allocation request from the first program. The first memory area is provided from the first memory device, for example, a WIDE I/O that has a relatively higher bandwidth.

In operation 1170, the electronic device (for example, the memory manager 222) receives a memory allocation request from a second program. For example, the second program is a program of a user space, which is an application. In operation 1190, the electronic device (for example, the memory manager 222) preferentially allocates the second memory area to the second program in response to the memory allocation request from the second program. For example, the second memory area is provided from the second memory device, for example, an LPDDR that has a relatively lower bandwidth.

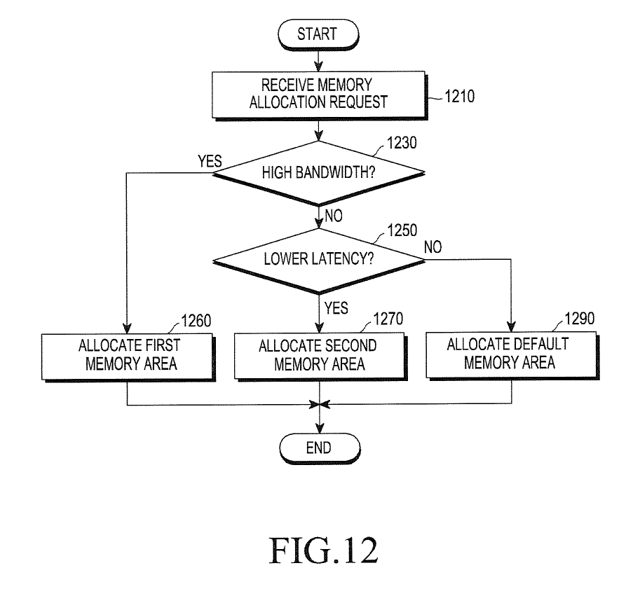

FIG. 12 is a flowchart illustrating an example of a method for an electronic device (for example, the electronic device 101) to allocate a memory area according to this disclosure. Referring to FIG. 12, in operation 1210, the electronic device (for example, the memory manager 222) receives a memory allocation request from a program. In operation 1230, the electronic device determines whether the program requires a higher bandwidth. In operation 1260, when the program requires a higher bandwidth, the electronic device (for example, the memory manager 222) allocates, to the program, a first memory area that is relatively higher bandwidth, such as a WIDE I/O.

In operation 1250, when the program does not require a high bandwidth, the electronic device determines whether the program requires a low latency. In operation 1270, when the program requires a low latency, the electronic device (for example, the memory manager 222) allocates, to the program, a second memory area that is relatively lower bandwidth, such as an LPDDR. According to an embodiment of the present disclosure, to determine whether the program requires a high bandwidth or a low latency, the memory manger uses a flag (for example, a flag included in a memory allocation request) corresponding to the program, uses a program list stored in advance in the memory manager, or uses a bandwidth corresponding to the program (for example, a bandwidth that the program requires and is included in the memory allocation request).

According to an embodiment of the present disclosure, in operation 1290, when the program does not require a low latency, the electronic device (for example, the memory manager 222) allocates a default memory area to the program. The default memory area is determined in advance based on, for example, a type of program. For example, the first memory area is designated in a program of a kernel space, and the second memory area is designated in a program of a user space. According to an embodiment of the present disclosure, when the memory manager collects a memory from the program, the memory manager preferentially collects the memory area of the first memory device than the memory area of the second memory device. For example, to obtain a free area, the memory manager preferentially secures the memory area of the first memory device that has a relatively higher bandwidth.

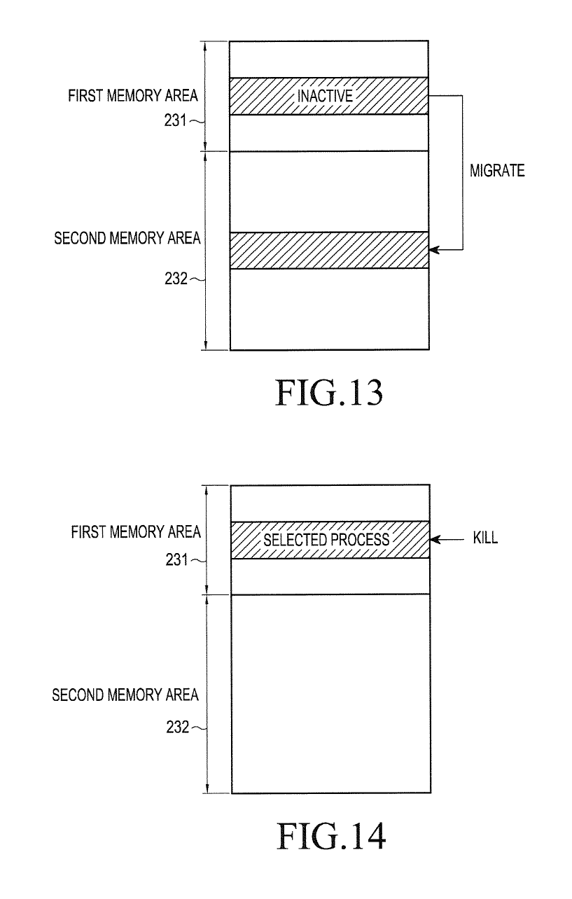

FIG. 13 illustrates an example of managing a memory area in an electronic device (for example, the electronic device 101) according to this disclosure. Referring to FIG. 13, when a memory space of a first memory device (for example, the first memory device 173) is insufficient, a memory manager (for example, the memory manager 222) migrates inactive data that is stored in the memory area 231 of the first memory device to the memory area 232 of a second memory device (for example, the second memory device 175). The inactive data indicates, for example, data that is not accessed during at least a predetermined period of time. According to an embodiment of the present disclosure, the inactive data is migrated based on a page unit. The memory manager secures the space where the inactive data has existed as a free area of the first memory device.

FIG. 14 illustrates an example of allocating a memory area in an electronic device (for example, the electronic device 101) according to this disclosure. Referring to FIG. 14, when a memory space of a second memory device (for example, the second memory device 175) is insufficient, as well as a first memory device (for example, the first memory device 173), a memory manager (for example, the memory manager 222) kills the process. The process indicates, for example, a program that is loaded onto a memory and is currently executed. The memory manager preferentially kills the currently executed process using the memory area 231 of the first memory device. For example, the memory manager 222 secures a space where the process is killed as a free area of the first memory device.

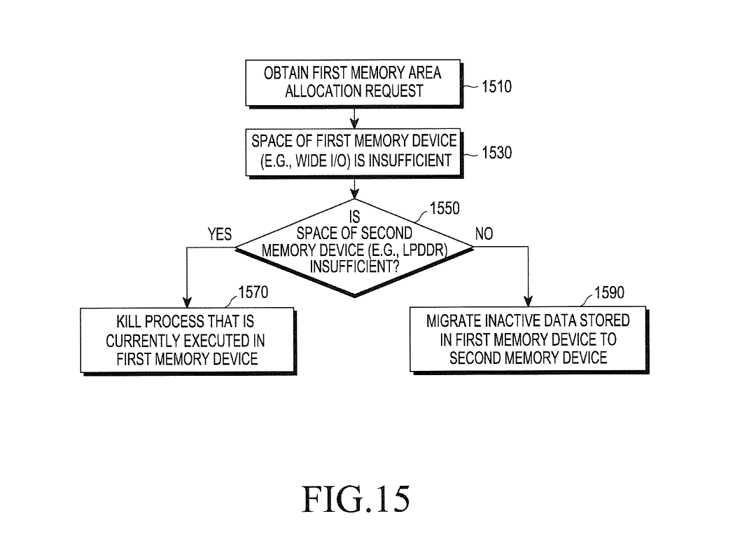

FIG. 15 is a flowchart illustrating an example of a method for an electronic device (for example, the electronic device 101) to manage a memory area according to this disclosure. Referring to FIG. 15, in operation 1510, the electronic device (for example, the memory manager 222) obtains an allocation request for requesting the allocation of a first memory area (for example, a memory area corresponding to the first memory device 173). For example, the electronic device obtains a request for collecting the memory area of the first memory device. In operation 1530, the memory manager determines that a memory space of the first memory device (for example, WIDE I/O) is insufficient. In operation 1550, when the memory space of the first memory device is insufficient, the memory manager determines whether the space of a second memory device (for example, LPDDR) is insufficient. In operation 1570, when the space of the second memory device is insufficient, the memory manager kills inactive data that is stored in the memory area of the first memory device. For example, the memory manager preferentially kills at least one process that is currently executed using the memory area of the first memory device. In operation 1590, when it is determined that the space of the second memory device is insufficient, the memory manager migrates at least some of the data that is stored (or currently executed) in the first memory device to the memory area of the second memory device.

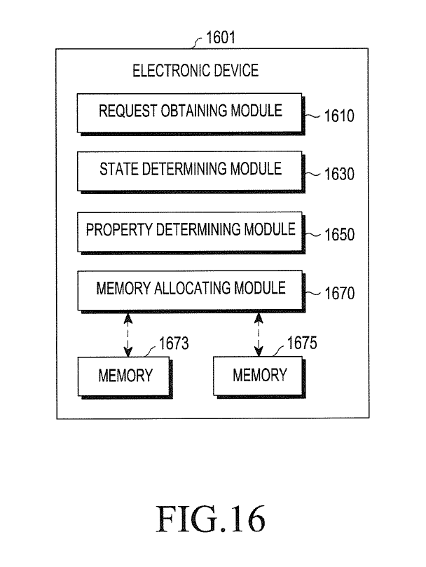

FIG. 16 is a block diagram of an electronic device (for example, the electronic device 101) according to this disclosure. The description that is identical or similar to FIGS. 1 to 15 will be omitted in the description associated with an electronic device 1601. Referring to FIG. 16, the electronic device 1601 includes, for example, a request obtaining module 1610, a state determining module 1630, a property determining module 1650, a memory allocating module 1670, a memory 1673 (hereinafter referred to as “first memory” for ease of description), and a memory 1675 (hereinafter referred to as “second memory” for ease of description) 1675. According to an embodiment of the present disclosure, at least one of the request obtaining module 1610, the state determining module 1630, the property determining module 1650, and the memory allocating module 1670 is included in the memory manager (for example, the memory manager 222).

The request obtaining module 1610 receives, for example, a memory allocation request from at least one process. According to an embodiment of the present disclosure, when data to be executed through the electronic device 1601 exists, the process corresponding to the data (for example, the process that receives an event associated with the data) requests the allocation of a memory from the request obtaining module 1610 to secure a memory area for the data. For example, the request obtaining module 1610 receives, from at least one process, a memory allocation request in association with at least some data corresponding to the at least one process to be executed in the electronic device (for example, new data corresponding to the at least one process (hereinafter referred to as “new data”)).

For example, a predetermined application (for example, a camera application) is executed through the electronic device 1601. In this instance, a process corresponding to the predetermined application is loaded onto at least one of the first memory 1673 (for example, the first memory device 173) and the second memory 1675 (for example, the second memory device 175), and requests the allocation of a memory for new data to be obtained through the predetermined application. For example, when a request for obtaining a photo through the camera application is generated by a user input or automatically, a process corresponding to the camera application that determines the request requests, from the request obtaining module 1610, the allocation of a memory area for loading new data associated with the photo.

The state determining module 1630 determines, for example, at least one state in association with the electronic device 1601 (for example, the temperature of the electronic device 1601 or the like). According to an embodiment of the present disclosure, the state determining module 1630 determines at least one state in response to the memory allocation request requested from the at least one process. The at least one state includes, for example, various types of states in association with one or more elements included in the electronic device 1601. For example, at least one state includes setting information of the electronic device 1601, a driving frequency/current consumption corresponding to a driving state of the one or more elements, the temperature of the electronic device 1601, and the like.

The setting information of the electronic device 1601 includes, for example, a normal usage mode and a power-saving mode. For example, the normal usage mode does not put a specific restriction on the current consumption of the electronic device 1601, and drives the electronic device 1601 based on the driving information set to be default. Conversely, when it is desired to reduce the current consumption based on a current residual quantity of the battery or the like, the power-saving mode restricts a function associated with at least one element of the electronic device 1601 or reduces a driving current, and drives the electronic device 1601 at a low power.

According to an embodiment of the present disclosure, the driving frequency includes a driving frequency associated with a processor (for example, the processor 120), a first memory 1673, or a second memory 1675 of the electronic device 1601 (for example, a driving frequency that currently drives the elements or the maximum driving frequency that is currently set). According to an embodiment of the present disclosure, the at least one state includes a usable memory space of the first memory 1673 or the second memory 1657, a current temperature of the electronic device 1601, a residual quantity of a battery, an operating current associated with one or more elements, and the like. According to an embodiment of the present disclosure, the at least one state further includes performance information corresponding to the one or more elements. For example, the maximum driving frequency that the processor maximally supports includes the capacity information of the first memory 1673 and the second memory 1675 (for example, the maximum storage capacity, total capacity, used capacity, free capacity, shared capacity, and the like)/ performance information (for example, a bandwidth or the number of bits) and the like.

The property determining module 1650 determines, for example, the property of at least one process. According to an embodiment of the present disclosure, the property determining module 1650 determines, as the property, an estimated driving time of the at least one process, the number of frames processed per unit time (for example, the number of frames processed per second), the data capacity corresponding to the at least one process, a driving state of an application corresponding to the process, and the like. For example, when a first process corresponds to a video playback application, the property determining module 1650 determines, to be a first time, an estimated driving time corresponding to the first process. Conversely, when a second process corresponds to an album application, the property determining module 1650 determines an estimated driving time corresponding to the second process, to be a second time which is shorter than the first time.

As another example, the property determining module 1650 determines, to be a first fps, the number of frames per second (fps) in association with a process corresponding to a camera application that uses a high definition (for example, full high definition (FHD)). Conversely, the property determining module 1650 determines the number of frames per second in association with a process corresponding to a camera application that uses a low definition (for example, HD), to be a second fps that is smaller than the first fps According to an embodiment of the present disclosure, when there is a memory allocation request from the at least one process for the allocation of a memory for at least some data to be executed through the electronic device 1601 (for example, new data corresponding to the at least one process), the property determining module 1650 determines the property corresponding to the at least some data.

According to an embodiment of the present disclosure, the property determining module 1650 determines whether the current state is a foreground or background with respect to a process corresponding to an application. According to an embodiment of the present disclosure, a multi-tasking operating system environment manages currently operated applications by distinguishing a single foreground application (having focus) and the plurality of remaining background applications. According to an embodiment of the present disclosure, an operating system manages a single foreground window or a single focus object in association with a UI object that is shown on a screen of the foreground application.

The memory allocating module 1670 allocates, for example, at least a partial area of one of the first memory 1673 and the second memory 1675 to at least some data of at least one process to be executed in the electronic device 1601, based on the at least one state. According to an embodiment of the present disclosure, the memory allocating module 1670 selects one of the first memory 1673 and the second memory 1675 based on the at least one state. Also, the memory allocating module 1670 loads the at least some data onto the one selected memory.

According to an embodiment of the present disclosure, the memory allocating module 1670 allocates one of the first memory 1671 and the second memory 1673 to the at least some data, based on the temperature of the electronic device 1601 which corresponds to one of the at least one state. For example, when the temperature of the electronic device 1601 is a first temperature (for example, approximately 30 degrees), the memory allocating module 1670 allocates, to the at least some data, at least a partial area of the first memory 1673 having a first heat radiating performance (for example, approximately 90%). Conversely, when the temperature of the electronic device 1601 is a second temperature (for example, approximately 15 degrees), the memory allocating module 1670 allocates, to the at least some data, at least a partial area of the second memory 1675 having a second heat radiating performance (for example, approximately 60%).

According to an embodiment of the present disclosure, the memory allocating module 1670 selects a memory to be allocated to the at least some data based on the temperature of a predetermined element, in addition to the temperature of the entire electronic device 1601. For example, when the temperature of the first memory 1673 is a first temperature (for example, approximately 20 degrees) and the temperature of the second memory 1675 is a second temperature (for example, approximately 30 degrees) which is a higher than the first temperature, the memory allocating module 1670 loads the at least some data onto the first memory 1673, so as to lower the temperature of the second memory 1675. As another example, the memory allocating module 1670 selects a memory that is allocated to the at least some data based on the temperature of other elements, such as a processor (for example, the processor 120), a display (for example, the display 140), and the like of the electronic device 1601.

According to an embodiment of the present disclosure, the memory allocating module 1670 allocates one of the first memory 1673 and the second memory 1675 to the at least some data, based on the current consumption or residual quantity of a battery of the electronic device 1601 which corresponds to one of the at least one state. For example, the current consumption of the electronic device 1601 can be inferred based on a variation in a residual quantity of a batter during a predetermined period of time. For example, when the current consumption or the residual quantity of the battery of the electronic device 1601 is a first current consumption or a first battery residual quantity (for example, approximately 90%) which is relatively higher, the memory allocating module 1670 allocates, to the at least some data, a memory that has a relatively lower current consumption (for example, the first memory 1673 such as a WIDE I/O) out of the first memory 1673 and the second memory 1675. Conversely, when the current consumption or the residual quantity of the battery of the electronic device 1601 is a second current consumption or a second battery residual quantity (for example, approximately 5%) which is relatively lower, the memory allocating module 1670 allocates, to the at least some data, a memory that has a relatively higher current consumption (for example, the second memory 1675 such as an LPDDR) out of the first memory 1673 and the second memory 1675.

According to an embodiment of the present disclosure, the memory allocating module 1670 adjusts a driving frequency associated with at least one of the first memory 1673 and the second memory 1675 when the temperature of the electronic device 1601 or the current consumption or residual quantity of the battery is included in a designated range. For example, when the temperature of the electronic device 1601 exceeds approximately 35 degrees, the memory allocating module 1670 lowers the maximum driving frequency (for example, max clock) for the at least one memory from a first driving frequency (for example, approximately 120 Hz) to a second driving frequency (for example, approximately 60 Hz), so as to adjust the temperature of the electronic device 1601. According to an embodiment of the present disclosure, the memory allocating module 1670 adjusts the driving frequency of a memory that has a higher temperature out of the first memory 1673 and the second memory 1675, and thereby adjusting the heat radiating or current consumption of the electronic device 1601.

According to an embodiment of the present disclosure, the memory allocating module 1670 selects a memory to be allocated to the at least some data based on a usage mode of the electronic device 1601, which corresponds to at least one state. For example, when the usage mode of the electronic device 1601 is a normal usage mode, the memory allocating module 1670 allocates the first memory 1673 or the second memory 1675 to the at least some data without considering the current consumption of the first memory 1673 and the second memory 1675. For example, the memory allocating module 1670 allocates a default memory designated based on the at least some data to the at least some data. Alternatively, the memory allocating module 1670 selects, for example, at least one of the first memory 1673 and the second memory 1675 based on another state of the electronic device 1601 (for example, the temperature of the electronic device 1601, or the driving frequency of the processor (for example, the processor 120).

Conversely, when the usage mode of the electronic device 1601 is a power-saving mode, the memory allocating module 1670 allocates a memory that has a lower current consumption out of the first memory 1673 and the second memory 1675, to the at least some data. For example, when the current consumption of the first memory 1673 is a first current consumption and the current consumption of the second memory 1675 is a second current consumption that is higher than the first current consumption, the memory allocating module 1670 loads at least some data to the first memory 1673. According to an embodiment of the present disclosure, in the power-saving mode, the memory allocating module 1670 allocates at least some data of the at least one process to a memory selected based on user setting or the like. For example, when the first memory 1673 is selected based on the user setting, the memory allocating module 1670 loads the at least some data to the first memory 1673. In this instance, the memory allocating module 1670 may not load new data corresponding to one or more processors onto the second memory 1675 which is not selected.

According to an embodiment of the present disclosure, the power-saving mode includes a usage restriction mode associated with the first memory 1673 or the second memory 1675. For example, based on a user input, when the first memory 1673 is selected to be a usage restriction mode, the memory allocating module 1670 decreases the voltage associated with the first memory 1673, lower the first memory driving frequency, or limit an amount of usage of the first memory 1673. Conversely, when the second memory 1675 is selected to be a usage restriction mode, the memory allocating module 1670 decreases the voltage associated with the second memory 1673, lower the second memory driving frequency, or limit an amount of usage of the second memory 1675.

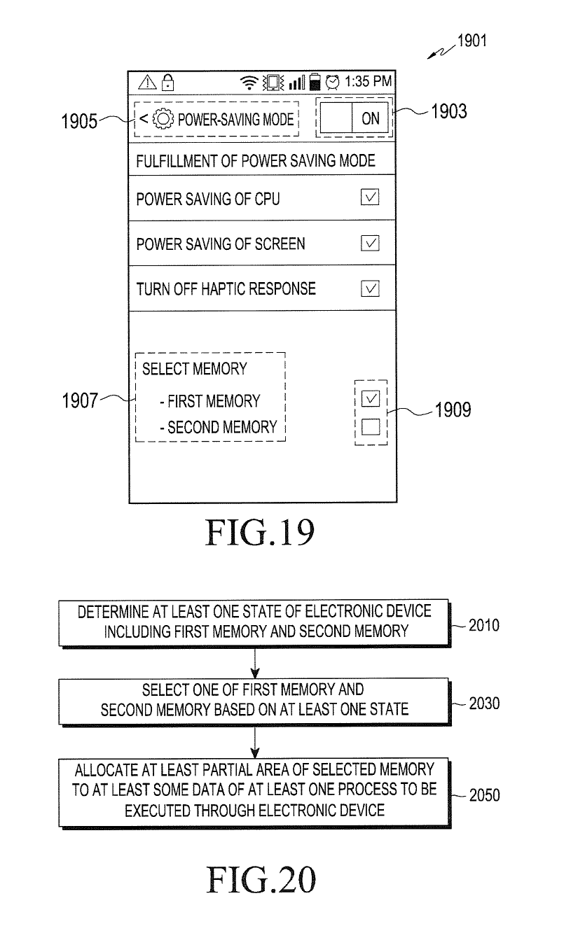

According to an embodiment of the present disclosure, a user interface used for selecting a memory that is usable in the power-saving mode is provided. In this instance, a user freely selects one of the normal usage mode and the power-saving mode through the user interface, and freely selects a memory to be used in the power-saving mode out of the first memory 1673 or the second memory 1675. According to an embodiment of the present disclosure, the user interface includes visual information used for selecting a usage restriction mode of the first memory 1673 or the second memory 1675. Additional information associated with a user interface for selecting a memory will be described below with reference to FIG. 19.

According to an embodiment of the present disclosure, the memory allocating module 1670 selects a memory to be allocated to at least some data of the at least one process, additionally based on the property of the at least one process. For example, when a driving time of the at least one process (for example, watching a video) is a first time (for example, approximately two hours), the memory allocating module 1670 loads the at least some data to the first memory 1673 of which current consumption is relatively lower. For example, when a driving time of the at least one process (for example, viewing photos in an album) is a second time (for example, approximately one minute), the memory allocating module 1670 loads the at least some data to any of the first memory 1673 and the second memory 1675, irrespective of the current consumption or the residual quantity of the battery. According to an embodiment of the present disclosure, when data to be preferentially allocated to the first memory 1673 of which the current consumption is relatively lower exists, the memory allocating module 1670 loads the at least some data to the second memory 1675.

According to an embodiment of the present disclosure, when the number of frames per unit time of at least one process (for example, recording executed by a dual-camera with high definition) is a first 1 fps, the memory allocating module 1670 allocates, to the at least some data, the first memory 1673 of which the current consumption is relatively lower. Conversely, when the number of frames per unit time of at least one process (for example, viewing photos in an album) is a second fps which is smaller than the first fps, the memory allocating module 1670 allocates, for example, the second memory 1675 of which the current consumption is relatively higher, to the at least some data. The property of the electronic device 1601 includes, for example, an amount of memory required, a driving frequency of a corresponding CPU, and the like, in addition to the driving time or the number of frames per unit time.

According to an embodiment of the present disclosure, although the memory allocating module 1670 selects a memory to be allocated to the at least some data based on at least one state of the electronic device 1601, as the first memory 1673 (or the second memory 1675), the memory allocating module 1670 preferentially selects the second memory 1675 (for example, the first memory 1673) based on the property of the at least one process. For example, when the temperature of the electronic device 1601 is relatively higher, the memory allocating module 1670 selects the first memory 1673 which has a relatively better heat radiating function as a memory for new data. However, the memory allocating module 1670 loads the new data to the second memory 1675, based on the property of a process corresponding to the new data.

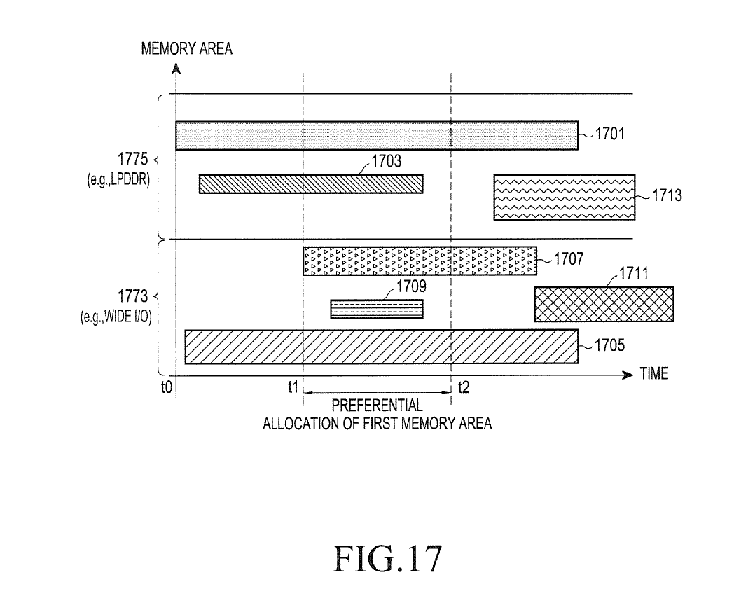

According to an embodiment of the present disclosure, when one of the first memory 1673 and the second memory 1675 is allocated to the at least some data, the memory allocating module 1670 allocates one of the memories to data that is newly generated during a designated period of time. For example, when the first memory 1673 is allocated to the at least some data, the memory allocating module 1670 loads the data that is newly generated during approximately 5 minutes to the first memory 1673. Conversely, when the second memory 1675 is allocated to the at least some data, the memory allocating module 1670 allocates the data that is newly generated during approximately 3 minutes to the second memory 1675. The designated time is adjusted to be various values, based on, for example, the state, the performance, the user setting, and the like of the electronic device 1601. Additional description in association with the allocation of a memory to new data will be described with reference to FIG. 17.

According to an embodiment of the present disclosure, the memory allocating module 1670 adjusts a driving frequency (clock frequency) or the maximum driving frequency (max clock frequency) of the processor (for example, the processor 120) based on a memory to be allocated to the at least some data. For example, when at least a partial area of the first memory 1673 is allocated to the at least some data, the memory allocating module 1670 adjusts a driving frequency or the maximum driving frequency of the processor from a first driving frequency (for example, a driving frequency that currently drives the processor) to a second driving frequency.

Conversely, when at least a partial area of the second memory 1675 is allocated to the at least some data, the memory allocating module 1670 adjusts a driving frequency or the maximum driving frequency of the processor from a first driving frequency to a third driving frequency. When the first memory 1673 is selected that has a first bandwidth which is relatively higher, the memory allocating module 1670 increases a driving frequency of the processor and improves the data processing rate of the electronic device 1601. In this instance, an amount of heat that is increasingly generated as the driving frequency of the processor is increased is offset by a heat radiating performance of the first memory 1673 (the performance is better than the heat radiating performance of the second memory 1675).

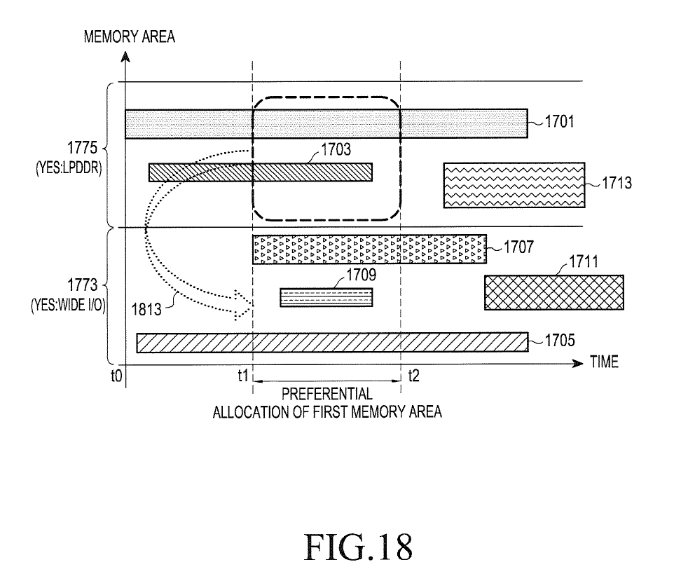

According to an embodiment of the present disclosure, when a memory to be allocated to the at least some data is selected, the memory allocating module 1670 migrates at least some of the data that has been loaded onto another memory which is not selected to the selected memory. For example, when at least a partial area of the first memory 1673 is allocated to the at least some data, the memory allocating module 1670 migrates at least some of the data that has been loaded onto the second memory 1675 to the first memory 1673. Conversely, when at least a partial area of the second memory 1675 is allocated to the at least some data, the memory allocating module 1670 migrates the data that has been loaded onto the first memory 1675 to the second memory 1675. The additional information associated with the migration of a memory will be described below with reference to FIG. 18.

According to an embodiment of the present disclosure, when one (for example, the first memory 1673) of the first memory 1673 and the second memory 1675 is selected for the at least some data, the memory allocating module 1670 changes the other memory (for example, the second memory 1675) from a normal usage mode to a lower usage mode. In the normal usage mode, the memory allocating module 1670 loads new data or access the loaded data without putting a special restriction on the performance of the first memory 1673 or the second memory 1675. Conversely, in the low usage mode, for example, the memory allocating module 1670 no longer loads new data onto a memory set to be a low usage mode.

According to an embodiment of the present disclosure, when the memory is set to be a low usage mode, the memory allocating module 1670 accesses data that has already been loaded onto the memory that is set to be the low usage mode. According to an embodiment of the present disclosure, a driving frequency or the maximum driving frequency of the memory that is selected to be the low usage mode is lower than a driving frequency or the maximum driving frequency of the normal usage mode. Also, the voltage that is provided to the memory that is selected to be the low usage mode is lower than the voltage provided in the normal usage mode. According to an embodiment of the present disclosure, the memory allocating module 1670 blocks the voltage provided to another memory that is not selected. According to an embodiment of the present disclosure, when the first memory or the second memory is set to be low usage mode, a driving frequency or the maximum driving frequency of the processor is changed to be lower than the driving frequency or the maximum driving frequency of the normal usage mode.

According to an embodiment of the present disclosure, the first memory 1673 is a memory device having a first bandwidth (for example, a memory device embodied to be approximately 512 bits), and includes, for example, a WIDE I/O. Conversely, the second memory 1675 is a memory device (for example, a memory device embodied to be approximately about 32 bits) that has a second bandwidth which is relatively lower than the first bandwidth, and includes, for example, an LPDDR. According to an embodiment of the present disclosure, the first memory 1673 has a better heat radiating performance than the second memory 1675. For ease of description, although the description associated with new data has been described, the technologies described above can be applied to data that has already been allocated to a memory (hereinafter referred to as “exiting data” for ease of description) in addition to the new data. For example, the technologies described in the present document may not only be applied to the new data, but can be applied to the existing data according to the embodiment of the technology.

FIG. 17 illustrates an example of allocating a memory in an electronic device (for example, the electronic device 1601) according to this disclosure. Referring to FIG. 17, a first memory area 1773 is, for example, an area corresponding to a first memory device (for example, the first memory 1673). According to an embodiment of the present disclosure, the first memory device includes a WIDE I/O. A second memory area 1775 is, for example, an area corresponding to a second memory device (for example, the second memory 1675). According to an embodiment of the present disclosure, the second memory device includes an LPDDR.

According to an embodiment of the present disclosure, during a first time section (t0˜t1), a memory allocating module (for example, the memory allocating module 1670) loads data onto the first memory area 1773 or the second memory area 1775 according to a general scheme. For example, when the temperature of the electronic device is included in a normal range (for example, within approximately 15 degrees) or when it is determined that there is no special issue among other states of the electronic device, the memory allocating module allocates corresponding data to a memory basically designated for the data. For example, first data 1701 and second data 1703 are allocated to the second memory area 1775, and third data 1705 is allocated to the first memory area 1773.

According to an embodiment of the present disclosure, during a second time section (t1˜t2), when the first memory area 1773 is selected based on at least one state of the electronic device, the memory allocating module loads new data preferentially to the first memory area 1773 than the second memory area 1775. For example, the memory allocating module loads, onto the first memory area 1773, first new data 1707 and second new data 1709 which are generated after a first point in time (t1). In this instance, the memory allocating module may not load new data onto the second memory area 1775. For example, when new data is generated, the memory allocating module allocates only the first memory area 1773 for the new data. According to an embodiment of the present disclosure, although new data is preferentially loaded onto the first memory area 1773, the first data 1701 and the second data 1703 which are loaded onto the second memory area 1775 during the first time section (t0˜t1) still uses the second memory area 1775.

According to an embodiment of the present disclosure, after a third time section (after t2), when there is no need to preferentially allocate the first memory area 1773 to new data based on a change in the state of the electronic device, the memory allocating module, for example, distributes the new data to the first memory area 1773 or the second memory area 1775, in the same manner as the first time section (t0˜t1). For example, the third new data 1711 is loaded onto the first memory area 1773, and the fourth new data 1713 is loaded onto the second memory area 1775. According to an embodiment of the present disclosure, the data loaded onto the first memory 1773 or the second memory 1775 corresponds to one or more processes. For example, the first data 1701 and the second data 1703 are data associated with a first process, or are data associated with the first process and a second process which is different from the first process.

FIG. 18 illustrates an example of allocating a memory in an electronic device (for example, the electronic device 1601) according to this disclosure. The descriptions that are identical or similar to the descriptions of FIG. 17 will be omitted. Referring to FIG. 18, in a first time section (t0˜t1), the first data 1701 and the second data 1703 are loaded onto the second memory area 1775, and the third data 1705 is allocated to the first memory area 1773. In a second time section (t1˜t2), when the first memory area 1773 is preferentially used over the second memory area 1775, the first new data 1707 and the second new data 1709 are loaded onto the first memory area 1773. According to an embodiment of the present disclosure, in the second time section (t1˜t2), at least some of the first data 1701 and the second data 1703 allocated to the second memory area 1775 are migrated to the first memory area 1773.

According to an embodiment of the present disclosure, in a third time section (after t2), third new data 1711 and fourth new data 1713 are allocated to, for example, the first memory area 1773 or the second memory area 1775 as designated basic memories. According to an embodiment of the present disclosure, when data that is continuously executed after the third time section (after t2) exists among the first data 1701 and the second data 1703 which have been migrated to the first memory area 1773, the currently executed data is migrated again to the second memory area 1775. For example, the first data 1701 is continuously executed after the third time section (after t2), and the first data 1701 is migrated again to the second memory area 1775.

FIG. 19 illustrates an example of a user interface for selecting a usage mode in an electronic device according to various embodiments of the present disclosure. Referring to FIG. 19, a user interface 1901 includes visual information 1903 (for example, numbers, text, images, or icons) for selecting a power-saving mode 1905. A user selects the power-saving mode 1905 through an input associated with the visual information 1903 (for example, a hovering over the visual information 1903 or touching the first visual information 1903). For example, by touching the visual information 1903 shown as “ON”, the user changes the usage mode of the electronic device (for example, the electronic device 1601) from a normal usage mode to the power-saving mode 1905.

Also, by touching the visual information 1903 shown as “OFF”, the user changes the usage mode of the electronic device from the power-saving mode 1905 to the normal usage mode.

According to an embodiment of the present disclosure, the user interface 1901 includes second visual information 1907 that selects a memory to be used in the power-saving mode 1905. For example, the second visual information 1907 includes visual information corresponding to a first memory (for example, the first memory 1673) and visual information corresponding to a second memory (for example, the second memory 1675). Also, the user interface 1901 includes third visual information 1909 (for example, a check box) for selecting one of the first memory and the second memory. The third visual information 1909 includes a check box corresponding to the first memory and a check box corresponding to the second memory. The user interface 1901 illustrated in FIG. 19 can be provided in various forms. For example, although not illustrated, an icon is located between the first memory and the second memory. By moving the icon to the side of the first memory or to the side of the second memory, the user selects one of the first memory and the second memory.

According to an embodiment of the present disclosure, an electronic device includes a first memory, a second memory, and a processor that is functionally connected with the first memory and the second memory, and the processor executes determining at least one state associated with the electronic device, and allocating at least a partial area of one of the first memory and the second memory to at least some data of at least one process to be executed in the electronic device, based on the at least one state.

According to an embodiment of the present disclosure, the first memory includes a memory having a first bandwidth, and the second memory includes a memory having a second bandwidth. According to an embodiment of the present disclosure, the processor obtains a memory allocation request for requesting the allocation of a memory corresponding to the at least some data, from the at least one processor, and determines the at least one state in response to the memory allocation request. According to an embodiment of the present disclosure, the processor converts the other memory among the first memory and the second memory from a normal usage mode to a low usage mode, based on the at least one state. According to an embodiment of the present disclosure, the processor migrates, to the one memory, at least some data loaded onto the other memory among the first memory and the second memory.

According to an embodiment of the present disclosure, the processor determines a usage mode of the electronic device as the at least one state, and selects, as the one memory, a memory that consumes a lower current from among the first memory and the second memory when the usage mode is a power-saving mode. According to an embodiment of the present disclosure, the at least one state includes a usage mode of the electronic device, and the processor displays a user interface that is capable of adjusting the usage mode, through a display that is functionally connected with the electronic device. According to an embodiment of the present disclosure, the processor displays first visual information corresponding to the first memory and second visual information corresponding to the second memory, as at least a part of the user interface.

According to an embodiment of the present disclosure, the processor sets, to a first frequency, a driving frequency of the processor that is functionally connected with the electronic device when the first memory is allocated to the at least some data as the one memory, and sets the driving frequency to a second frequency when the second memory is allocated to the at least some data as the one memory. According to an embodiment of the present disclosure, the processor determines a property of the at least one process, and determines the one memory based on the property.

According to an embodiment of the present disclosure, the property includes a driving time or the number of frames processed for each unit time, and the processor determines the first memory as the one memory when the driving time or the number of frames processed for each time unit corresponds to a first time or a first number associated with the number of frames, and determines the second memory as the one memory when the driving time or the number of frames processed for each time corresponds to a second time or a second number associated with the number of frames.

According to an embodiment of the present disclosure, the at least one state includes information associated with a temperature of the electronic device, and the processor adjusts a first driving frequency of at least one of the first memory and the second memory to a second driving frequency when the temperature is included in a designated range. According to an embodiment of the present disclosure, the at least one state includes a usage restriction mode of the first memory or the second memory, and the processor adjusts the usage restriction mode based on an input obtained through the electronic device. According to an embodiment of the present disclosure, a computer-readable recording medium that stores a program to implement operations of an electronic device that includes a first memory and a second memory, the operations including: determining at least one state of the electronic device; and allocating at least a partial area of one of the first memory and the second memory to at least some data of at least one process to be executed in the electronic device, based on the at least one state.

FIG. 20 illustrates an example of a method of allocating a memory area in an electronic device according to this disclosure. According to an embodiment of the present disclosure, in operation 2010, an electronic device (for example, the state determining module 1630) including a first memory (for example, the first memory 1673) and a second memory (for example, the second memory 1675) determines at least one state associated with the electronic device. The at least one state includes, for example, a temperature of the electronic device, a current consumption, a residual quantity of a battery, a driving frequency of a process, and the like.

According to an embodiment of the present disclosure, an electronic device (for example, the memory allocating module 1670) selects one of the first memory and the second memory based on the at least one state in operation 2030. For example, when the temperature of the electronic device is a first temperature (for example, approximately 30 degrees), the electronic device selects a first memory which shows a relatively better heat radiating performance. Conversely, when the temperature of the electronic device is a second temperature (for example, approximately 10 degrees), the electronic device may not consider the heat radiating performance of the first memory or the second memory. In this instance, the electronic device selects, for example, the second memory.

According to an embodiment of the present disclosure, in operation 2050, the electronic device (for example, the memory allocating module 1670) allocates at least a partial area of the selected memory to at least some data of at least one process to be executed through the electronic device. For example, while the at least one process is executed, when a request for executing new data exists, the electronic device allocates at least a partial area of the selected memory to the new data. For example, when the first memory is selected based on at least one state of the electronic device, the electronic device loads the new data onto the first memory. Conversely, when the second memory is selected based on at least one state of the electronic device, the electronic device loads the new data onto the second memory.

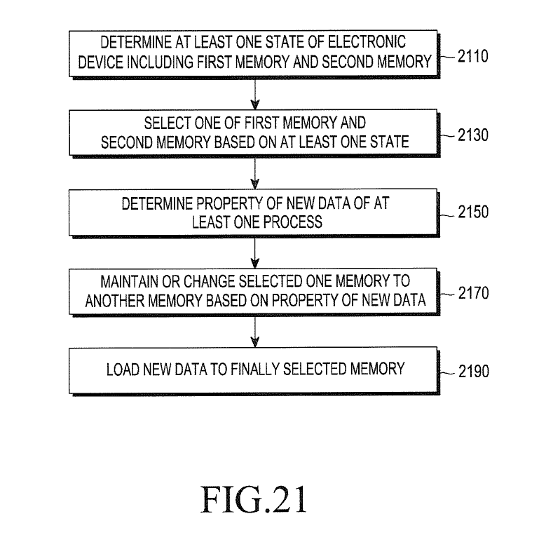

FIG. 21 illustrates an example of a method of allocating a memory area in an electronic device according to this disclosure. The descriptions that are identical or similar to the descriptions of FIG. 20 will be omitted. According to an embodiment of the present disclosure, the electronic device (for example, the state determining module 1630) determines at least one state of the electronic device in operation 2110. In operation 2130, the electronic device (for example, the memory allocating module 1670) selects one (the first memory) of the first memory and the second memory, based on the at least one state. According to an embodiment of the present disclosure, to finally determine a memory area to be allocated to new data, the electronic device (for example, the memory allocating module 1670) further determines the property of the new data or the property of a process corresponding to the new data in operation 2150.

According to an embodiment of the present disclosure, in operation 2170, the electronic device maintains the selected memory (for example, the first memory) as the memory to be allocated to the new data, based on the property, or changes the selected memory (for example, the first memory) to a memory that is not selected (for example, the second memory). For example, although the first memory is selected based on the temperature of the electronic device, when a data quantity of the new data is small or has a lower priority than another data, the electronic device changes the memory to be allocated to the new data from the first memory to the second memory.

According to an embodiment of the present disclosure, in operation 2190, the electronic device loads the new data onto the finally selected memory. According to various embodiments of the present disclosure, the electronic device selects one (for example, the first memory) of the first memory and the second memory based on the property of the process, to determine a memory area to be allocated to the new data. In this instance, when it is determined that another memory (for example, the second memory) that is not selected based on the property of the process is more proper based on the state of the electronic device, the electronic device allocates the process to the second memory.

As described above, an electronic device according to various embodiments of the present disclosure selects a memory to be allocated to new data based on at least one of the properties of a process and one or more states associated with the electronic device. According to various embodiments of the present disclosure, although one (for example, the first memory) of the first memory and the second memory is selected based on a property of a process, the electronic device loads, based on a state of the electronic device, the process to another memory (for example, the second memory) that is not selected. For example, when allocating the memory to the process, the electronic device preferentially considers the state of the electronic device, than the property of the process. Accordingly, the electronic device according to various embodiments improves the current consumption of the electronic device or an increase in temperature of the electronic device, and more efficiently uses a memory.

According to an embodiment of the present disclosure, there is provided a method of managing memory devices in an electronic device including a first memory and a second memory, and the method includes determining at least one state associated with the electronic device, and allocating at least a partial area of one of the first memory and the second memory to at least some data of at least one process to be executed in the electronic device, based on the at least one state.

According to an embodiment of the present disclosure, the operation of determining includes obtaining a memory allocation request for requesting the allocation of a memory corresponding to the at least some data, from the at least one process. According to an embodiment of the present disclosure, the operation of determining is executed in response to the memory allocation request. According to an embodiment of the present disclosure, the operation of allocating includes converting the other memory among the first memory and the second memory from a normal usage mode into a low usage mode, based on the at least one state. According to an embodiment of the present disclosure, the operation of allocating includes migrating, to the one memory, at least some data loaded onto the other memory among the first memory and the second memory.

According to an embodiment of the present disclosure, the at least one state includes information associated with a temperature of the electronic device, and the allocating includes adjusting a first driving frequency of at least one of the first memory and the second memory to a second driving frequency when the temperature is included in a designated range.

According to an embodiment of the present disclosure, the operation of allocating includes setting, to a first frequency, a driving frequency of the processor that is functionally connected with the electronic device when the first memory is allocated to the at least some data as the one memory, and setting the driving frequency to a second frequency when the second memory is allocated to the at least some data as the one memory.

According to an embodiment of the present disclosure, the operation of allocating includes determining a property of the at least one process, and determining the one memory additionally based on the property.

According to an embodiment of the present disclosure, the at least one state includes a usage restriction mode in association with the first memory or the second memory, and the method further includes adjusting the usage restriction mode based on an input obtained through the electronic device.

According to an embodiment of the present disclosure, the first memory includes a memory having a first bandwidth, and the second memory includes a memory having a second bandwidth.

According to an embodiment of the present disclosure, the operation of allocating includes determining a usage mode of the electronic device as the at least one state, and selecting, as the one memory, a memory that consumes a lower current from among the first memory and the second memory when the usage mode is a power-saving mode.

According to an embodiment of the present disclosure, the at least one state includes a usage mode of the electronic device, and the method further includes displaying a user interface that is capable of adjusting the usage mode, through a display that is functionally connected with the electronic device.

According to an embodiment of the present disclosure, the operation of displaying includes displaying first visual information corresponding to the first memory and second visual information corresponding to the second memory, as at least a part of the user interface.

According to an embodiment of the present disclosure, the property includes a driving time or the number of frames processed for each unit time, and the operation of allocating includes determining the first memory as the one memory when the driving time or the number of frames processed for each time unit corresponds to a first time or a first number associated with the number of frames, and determining the second memory as the one memory when the driving time or the number of frames processed for each time corresponds to a second time or a second number associated with the number of frames.

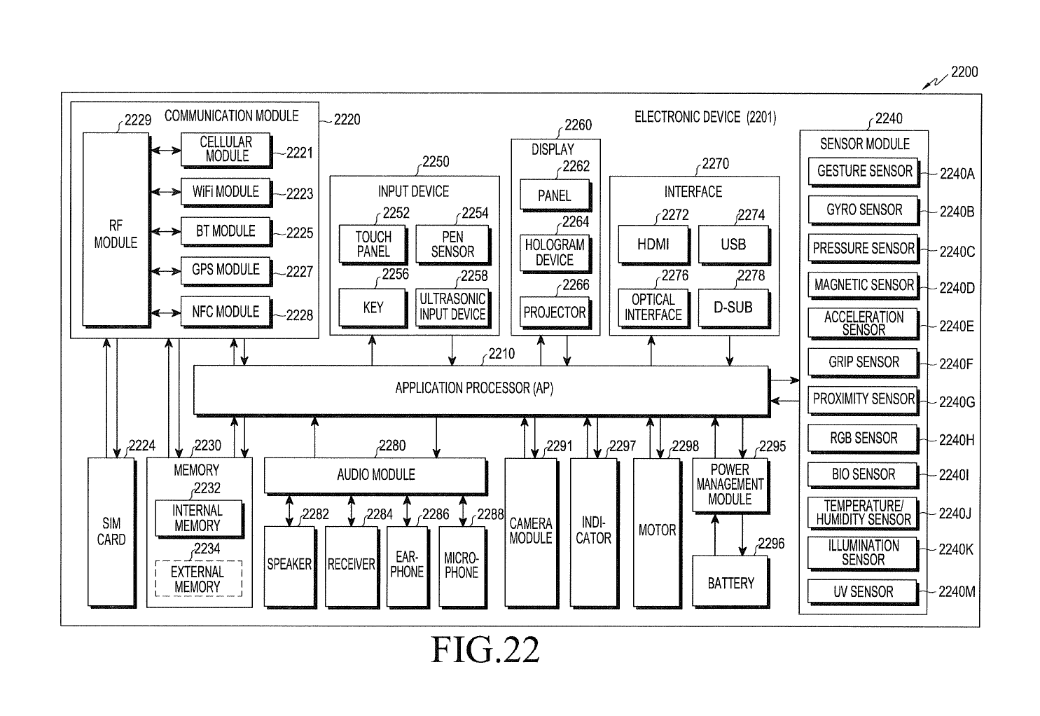

FIG. 22 is a block diagram of an electronic device 2200 according to various embodiments. For example, the electronic apparatus 2200 includes the whole or part of the electronic apparatus 101 illustrated in FIG. 1. The electronic device 2200 includes at least one Application Processor (AP) 2210, a communication module 2220, a Subscriber Identification Module (SIM) card 2224, a memory 2230, a sensor module 2240, an input device 2250, a display 2260, an interface 2270, an audio module 2280, a camera module 2291, a power management module 2295, a battery 2296, an indicator 2297, and a motor 2298.

The processor 2210 controls a plurality of hardware or software components connected to the processor 2210 by driving an operating system or an application program and perform processing of various pieces of data and calculations. The processor 2210 is implemented by, for example, a System on Chip (SoC). According to an embodiment, the processor 2210 further includes a Graphic Processing Unit (GPU) and/or an image signal processor. The processor 2210 includes at least some (e.g., a cellular module 2221) of the elements illustrated in FIG. 2. The processor 2210 loads, into a volatile memory, instructions or data received from at least one (e.g., a non-volatile memory) of the other elements and processes the loaded instructions or data, and stores various data in a non-volatile memory.

The communication module 2220 has a configuration equal or similar to that of the communication interface 150 of FIG. 1. The communication module 2220 includes, for example, a cellular module 2221, a Wi-Fi module 2223, a BLUETOOTH® module 2225, a GPS module 2227, an NFC module 2228, and a Radio Frequency (RF) module 2229.

The cellular module 2221 provides a voice call, image call, a text message service, or an Internet service through, for example, a communication network. According to an embodiment, the cellular module 2221 distinguishes between and authenticates electronic devices 2200 within a communication network using a subscriber identification module (for example, the SIM card 2224). According to an exemplary embodiment of the present disclosure, the cellular module 2221 performs at least some of the functions that the processor 2210 provides. According to an exemplary embodiment, the cellular module 2221 includes a Communication Processor (CP).

For example, each of the Wi-Fi module 2223, the BT module 2225, the GPS module 2227, and the NFC module 2228 includes a processor for processing data transmitted/received through the corresponding module. According to a specific exemplary embodiment, at least some (two or more) of the cellular module 2221, the WiFi module 2223, the BLUETOOTH® module 2225, the GPS module 2227, and the NFC module 2228 are included in one Integrated Chip (IC) or IC package.

The RF module 2229 transmits/receives, for example, a communication signal (for example, an RF signal). The RF module 2229 includes, for example, a transceiver, a Power Amp Module (PAM), a frequency filter, a Low Noise Amplifier (LNA), or an antenna. According to another exemplary embodiment, at least one of the cellular module 2221, the WiFi module 2223, the BT module 2225, the GPS module 2227, and the NFC module 2228 transmit/receive an RF signal through a separate RF module.

The subscriber identification module 2224 includes, for example, a card including a subscriber identity module and/or an embedded SIM, and contains unique identification information (e.g., an Integrated Circuit Card Identifier (ICCID)) or subscriber information (e.g., an International Mobile Subscriber Identity (IMSI)).

The memory 2230 (for example, the memory 130) includes, for example, an internal memory 2232 or an external memory 2234. The embedded memory 2232 includes at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 2234 further includes a flash drive, for example, a Compact Flash (CF), a Secure Digital (SD), a Micro Secure Digital (Micro-SD), a Mini Secure Digital (Mini-SD), an eXtreme Digital (xD), MultiMediaCard(MMC), a memory stick, or the like. The external memory 2234 is functionally and/or physically connected to the electronic device 2200 through various interfaces.

The sensor module 2240 measures a physical quantity or detects an operation state of the electronic device 2200, and converts the measured or detected information into an electrical signal. The sensor module 2240 includes, for example, at least one of a gesture sensor 2240A, a gyro sensor 2240B, an atmospheric pressure sensor 2240C, a magnetic sensor 2240D, an acceleration sensor 2240E, a grip sensor 2240F, a proximity sensor 2240G, a color sensor 2240H (for example, a red, green, blue (RGB) sensor), a biometric sensor 22401, a temperature/humidity sensor 2240J, a light sensor 2240K, and a ultraviolet (UV) sensor 2240M. Additionally or alternatively, the sensor module 2240 includes, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 2240 further includes a control circuit for controlling one or more sensors included therein. In some exemplary embodiments of the present disclosure, an electronic device 2200 further includes a processor configured to control the sensor module 2240 as a part of or separately from the processor 2210, and controls the sensor module 2240 while the processor 2210 is in a sleep state.

The input device 2250 includes, for example, a touch panel 2252, a (digital) pen sensor 2254, a key 2256, or an ultrasonic input device 2258. The touch panel 2252 uses at least one of, for example, a capacitive type, a resistive type, an infrared type, and an ultrasonic type. Also, the touch panel 2252 further includes a control circuit. The touch panel 2252 further includes a tactile layer and provides a tactile reaction to the user.

The (digital) pen sensor 2254 includes, for example, a recognition sheet which is a part of the touch panel or is separated from the touch panel. The key 2256 includes, for example, a physical button, an optical key or a keypad. The ultrasonic input device 2258 detects ultrasonic wavers generated by an input tool through a microphone (for example, a microphone 2288) and identifies data corresponding to the detected ultrasonic waves.

The display 2260 (for example, the display 160) includes a panel 2262, a hologram device 2264 or a projector 2266. The panel 2262 includes a configuration identical or similar to that of the display 140 illustrated in FIG. 1. The panel 2262 is implemented to be, for example, flexible, transparent, or wearable. The panel 2262 and the touch panel 2252 are implemented as one module. The hologram 2264 shows a three dimensional image in the air by using an interference of light. The projector 2266 displays an image by projecting light onto a screen. The screen is located, for example, inside or outside the electronic device 2200. According to an exemplary embodiment, the display 2260 further includes a control circuit for controlling the panel 2262, the hologram device 2264, or the projector 2266.

The interface 2270 includes, for example, a High-Definition Multimedia Interface (HDMI) 2272, a Universal Serial Bus (USB) 2274, an optical interface 2276, or a D-subminiature (D-sub) 2278. The interface 2270 is included in, for example, the communication interface 150 illustrated in FIG. 1. Additionally or alternatively, the interface 2270 includes, for example, a Mobile High-definition Link (MHL) interface, a Secure Digital (SD) card/Multi-Media Card (MMC) interface, or an Infrared Data Association (IrDA) standard interface.

The audio module 2280 bilaterally converts, for example, a sound and an electrical signal. At least some elements of the audio module 2280 are included in, for example, the input/output interface 130 illustrated in FIG. 1. The audio module 2280 processes sound information which is input or output through, for example, a speaker 2282, a receiver 2284, earphones 2286, the microphone 2288 or the like.

The camera module 2291 is a device which photographs a still image and a dynamic image. According to an embodiment, the camera module 291 includes one or more image sensors (for example, a front sensor or a back sensor), a lens, an Image Signal Processor (ISP) or a flash (for example, LED or xenon lamp).

The power management module 2295 manages, for example, power of the electronic device 2200. According to an embodiment, the power management module 2295 includes a Power Management Integrated Circuit (PMIC), a charger Integrated Circuit (IC), or a battery or fuel gauge. The PMIC uses a wired and/or wireless charging method. Examples of the wireless charging method include, for example, a magnetic resonance method, a magnetic induction method, an electromagnetic method, and the like. Additional circuits (e.g., a coil loop, a resonance circuit, a rectifier, etc.) for wireless charging can be further included. The battery gauge measures, for example, a residual quantity of the battery 2296, and a voltage, a current, or a temperature during the charging. The battery 2296 includes, for example, a rechargeable battery or a solar battery.

The indicator 2297 displays a particular state (e.g., a booting state, a message state, a charging state, or the like) of the electronic apparatus 2200 or a part (e.g., the processor 2210) of the electronic apparatus 2200. The motor 2298 converts an electrical signal into mechanical vibration, and generates vibration, a haptic effect, or the like. Although not illustrated, the electronic apparatus 2200 includes a processing unit (e.g., a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLOTM.

Each of the above-described component elements of hardware according to the present disclosure is configured with one or more components, and the names of the corresponding component elements varies based on the type of electronic device. The electronic device according to various embodiments of the present disclosure includes at least one of the aforementioned elements. Some elements are omitted or other additional elements are further included in the electronic device. Also, some of the hardware components according to various embodiments are combined into one entity, which perform functions identical to those of the relevant components before the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for an electronic device including a first memory and a second memory, the method comprising:
determining at least one state associated with the electronic device; and
allocating at least a partial area of at least one of the first memory or the second memory to at least some data of at least one process to be executed in the electronic device based on the at least one state.

2. The method of claim 1, wherein the determining comprises:
obtaining a memory allocation request for requesting the allocation of a memory corresponding to the at least some data from the at least one process.

3. The method of claim 2, wherein determining is executed in response to the memory allocation request.

4. The method of claim 1, wherein the allocating comprises:
converting the other memory among the first memory and the second memory from a normal usage mode into a low usage mode based on the at least one state.

5. The method of claim 4, wherein the converting comprises:
changing a driving frequency of a processor that is functionally connected with the electronic device from a first frequency into a second frequency.

6. The method of claim 1, wherein the allocating comprises:
migrating, to the one memory, at least some data loaded onto the other memory among the first memory and the second memory.

7. The method of claim 1, wherein the at least one state includes information associated with a temperature of the electronic device, and wherein the allocating comprises adjusting a first driving frequency of at least one of the first memory or the second memory to a second driving frequency when the temperature is included in a designated range.

8. The method of claim 1, wherein the allocating comprises:
determining a property of the at least one process; and
determining the one memory based on the property.

9. The method of claim 1, wherein the at least one state includes a usage restriction mode in association with the first memory or the second memory, and wherein the method further comprises adjusting the usage restriction mode based on an input obtained through the electronic device.

10. An electronic device, comprising:
a first memory;
a second memory; and
a processor that is functionally connected with the first memory and the second memory, wherein the processor is configured to:
determine at least one state associated with the electronic device, and allocate at least a partial area of one of the first memory and the second memory to at least some data of at least one process to be executed in the electronic device based on the at least one state.

11. The electronic device of claim 10, wherein the first memory includes a memory having a first bandwidth, and wherein the second memory includes a memory having a second bandwidth.

12. The electronic device of claim 10, wherein the processor is configured to:
obtain a memory allocation request for requesting the allocation of a memory corresponding to the at least some data from the at least one process, and
determine the at least one state in response to the memory allocation request.

13. The electronic device of claim 10, wherein the processor is configured to convert the other memory among the first memory and the second memory from a normal usage mode to a low usage mode based on the at least one state.

14. The electronic device of claim 10, wherein the processor is configured to:
determine a usage mode of the electronic device as the at least one state; and
select, as the one memory, a memory that consumes a lower current from among the first memory and the second memory when the usage mode is a power-saving mode.

15. The electronic device of claim 10, wherein the at least one state includes a usage mode of the electronic device, and wherein the processor is configured to display a user interface that is capable of adjusting the usage mode through a display that is functionally connected with the electronic device.

16. The electronic device of claim 15, wherein the processor is configured to display first visual information corresponding to the first memory and second visual information corresponding to the second memory as at least a part of the user interface.

17. The electronic device of claim 10, wherein the processor is configured to:
set, to a first frequency, a driving frequency of the processor that is functionally connected with the electronic device when the first memory is allocated to the at least some data as the one memory; and
set the driving frequency to a second frequency when the second memory is allocated to the at least some data as the one memory.

18. The electronic device of claim 10, wherein the processor is configured to:
determine a property of the at least one process; and
determine the one memory based on the property.

19. The electronic device of claim 18, wherein the property includes a driving time or a number of frames processed for each unit time, and wherein the processor is configured to:
determine the first memory as the one memory when the driving time or the number of frames processed for each time unit corresponds to a first time or a first number associated with the number of frames; and
determine the second memory as the one memory when the driving time or the number of frames processed for each time corresponds to a second time or a second number associated with the number of frames.

20. A computer-readable, storage-medium storing one or more executable programs that, when executed by one or more processors of an electronic device that includes a first memory and a second memory, cause the one or more processors to:
determine at least one state of the electronic device; and
allocate at least a partial area of one of the first memory and the second memory to at least some data of at least one process to be executed in the electronic device based on the at least one state.
